(19) United States
(12) Patent Application Publication
(10) Pub. No.: US 2023/0317352 A1
(43) Pub. Date: Oct. 5, 2023

(54) ELECTRONIC COMPONENT

(71) Applicant: TDK CORPORATION, Tokyo (JP)

(72) Inventors: Takeshi OOHASHI, Tokyo (JP); Michiyuki NAKAZAWA, Tokyo (JP); Takashi OHTSUKA, Tokyo (JP)

(73) Assignee: TDK CORPORATION, Tokyo (JP)

(21) Appl. No.: 18/191,374

(22) Filed: Mar. 28, 2023

(30) Foreign Application Priority Data
Mar. 29, 2022 (JP) 2022-053161
Jan. 13, 2023 (JP) 2023-003718

(51) Int. Cl. H01F 27/28; H01F 27/40

(52) U.S. Cl. CPC H01F 27/2804; H01F 27/402; H01F 2027/2809

(57) ABSTRACT

In an electronic component, a first inductor and a second inductor are disposed side by side in a first direction, and in a region where the first inductor and the second inductor are adjacent to each other in the first direction, at least one of positions in a second direction of an upper surface of a first inductor pattern, and an upper surface of a second inductor pattern and positions in the second direction of a lower surface of the first inductor pattern and a lower surface of a second inductor pattern, are different.

### TECHNICAL FIELD

The present disclosure relates to an electronic component.

### BACKGROUND

As an electronic component of the related art, for example, an electronic component described in Patent Literature 1 (Japanese Unexamined Patent Publication No. 2006-269653) is known. In the electronic component described in Patent Literature 1, a plurality of insulation layers on which conductive patterns are formed are stacked such that three inductors are formed inside the same element body. In the electronic component, among a first coil pattern (inductor pattern), a second coil pattern, and a third coil pattern forming the three inductors respectively, second coil pattern is formed at a stacking layer different from those of the other two coil patterns, and electromagnetic coupling between the coil patterns is performed in a stacking direction through the insulation layers existing therebetween.

### SUMMARY

In the electronic component of the related art, the inductors are formed by stacking the insulation layers on which the inductor patterns are formed. For example, when the inductor pattern of one inductor and the inductor pattern of the other inductor are disposed on different layers, the inductor patterns are separated from each other by at least a distance of one layer of the insulation layers.

One aspect of the present disclosure is intended to provide an electronic component in which magnetic coupling between inductors can be finely adjusted.

According to one aspect of the present disclosure, there is provided an electronic component including: an element body having a pair of end surfaces facing each other in a first direction, a pair of main surfaces including a first main surface and a second main surface facing each other in a second direction, and a pair of side surfaces facing each other in a third direction; and an inductor and a capacitor disposed inside the element body and forming a resonator. The inductor includes a first inductor including a first inductor pattern, and a second inductor including a second inductor pattern. The first inductor pattern has a first surface located toward the first main surface in the second direction, and a second surface located toward the second main surface in the second direction. The second inductor pattern has a third surface located toward the first main surface in the second direction, and a fourth surface located toward the second main surface in the second direction. The first inductor and the second inductor are disposed side by side in the top view from the second direction. In a region where the first inductor and the second inductor are adjacent to each other, at least one of positions in the second direction of the first surface of the first inductor pattern and the third surface of the second inductor pattern, and positions in the second direction of the second surface of the first inductor pattern and the fourth surface of the second inductor pattern, are different.

In the electronic component according to one aspect of the present disclosure, in the region where the first inductor and the second inductor are adjacent to each other, at least one of the positions in the second direction of the first surface of the first inductor pattern and the third surface of the second inductor pattern and the positions in the second direction of the second surface of the first inductor pattern and the fourth surface of the second inductor pattern are different. In such a manner, in the region where the first inductor and the second inductor are adjacent to each other, namely, in portions that are magnetically coupled, when the positions of the first surface of the first inductor pattern and the third surface of the second inductor pattern and/or the positions of the second surface of the first inductor pattern and the fourth surface of the second inductor pattern are differentiated, the degree of coupling in magnetic coupling between the first inductor and the second inductor changes. In such a manner, in the electronic component, magnetic coupling between the first inductor and the second inductor can be adjusted without depending on the thicknesses of insulation layers. Therefore, in the electronic component, magnetic coupling between the inductors can be finely adjusted.

In one embodiment, in the region where the first inductor and the second inductor are adjacent to each other, the first inductor pattern and the second inductor pattern each having one or more patterns, the number of the patterns may be different from each other. In such a manner, magnetic coupling between the first inductor and the second inductor can be adjusted by differentiating the number of the first inductor patterns and the number of the second inductor patterns.

In one embodiment, in the region where the first inductor and the second inductor are adjacent to each other, the first inductor pattern and the second inductor pattern may include portions facing each other in the first direction. In this configuration, since the first inductor pattern and the second inductor pattern include the facing portions, the degree of coupling in magnetic coupling between the first inductor and the second inductor can be finely adjusted.

In one embodiment, the second inductor pattern may include portions that face a plurality of the first inductor patterns. In this configuration, the degree of coupling in magnetic coupling between the first inductor and the second inductor can be increased.

In one embodiment, the first inductor pattern and the second inductor pattern may have different thicknesses in the second direction. In this configuration, in the region where the first inductor and the second inductor are adjacent to each other in the first direction, at least one of the positions in the second direction of the first surface of the first inductor pattern and the third surface of the second inductor pattern and the positions in the second direction of the second surface of the first inductor pattern and the fourth surface of the second inductor pattern can be configured to be different.

According to one aspect of the present disclosure, there is provided an electronic component including: an element body having a pair of end surfaces facing each other in a first direction, a pair of main surfaces including a first main surface and a second main surface facing each other in a second direction, and a pair of side surfaces facing each other in a third direction; and an inductor disposed inside the element body and forming a resonator. The inductor includes a first inductor including a first inductor pattern, and a second inductor including a second inductor pattern. The first inductor pattern has a first surface located toward the first main surface in the second direction, and a second surface located toward the second main surface in the second direction. The second inductor pattern has a third surface located toward the first main surface in the second direction, and a fourth surface located toward the second main surface in the second direction. The first inductor and the second inductor are disposed side by side in the top view from the second direction. In a region where the first inductor and the second inductor are adjacent to each other, at least one of positions in the second direction of the first surface of the first inductor pattern and the third surface of the second inductor pattern, and positions in the second direction of the second surface of the first inductor pattern and the fourth surface of the second inductor pattern, are different.

In the electronic component according to one aspect of the present disclosure, in the region where the first inductor and the second inductor are adjacent to each other, at least one of the positions in the second direction of the first surface of the first inductor pattern and the third surface of the second inductor pattern and the positions in the second direction of the second surface of the first inductor pattern and the fourth surface of the second inductor pattern are different. In such a manner, in the region where the first inductor and the second inductor are adjacent to each other, namely, in portions that are magnetically coupled, when the positions of the first surface of the first inductor pattern and the third surface of the second inductor pattern and/or the positions of the second surface of the first inductor pattern and the fourth surface of the second inductor pattern are differentiated, the degree of coupling in magnetic coupling between the first inductor and the second inductor changes. In such a manner, in the electronic component, magnetic coupling between the first inductor and the second inductor can be adjusted without depending on the thicknesses of insulation layers. Therefore, in the electronic component, magnetic coupling between the inductors can be finely adjusted.

In one embodiment, the first surface of the first inductor pattern may be located above the third surface of the second inductor pattern in the second direction.

In one embodiment, the second surface of the first inductor pattern may be located above the fourth surface of the second inductor pattern in the second direction.

In one embodiment, the first inductor pattern is formed over one or more layers in the second direction of the element body, the second inductor pattern is formed over one or more layers in the second direction of the element body, and in the region where the first inductor and the second inductor are adjacent to each other, the number of the layers in which the second inductor pattern is formed may be less than the number of the layers in which the first inductor pattern is formed.

In one embodiment, the first inductor pattern is formed over at least two layers and includes at least two portions in the region where the first inductor and the second inductor are adjacent to each other, each of the two portions being disposed in a different layer among the at least two layers, the second inductor pattern includes a portion being disposed in the region where the first inductor and the second inductor are adjacent to each other, the at least two portions of the first inductor pattern each may face the portion of the second inductor pattern in the first direction.

In one embodiment, in the region where the first inductor and the second inductor are adjacent to each other, the first inductor pattern and the second inductor pattern may include portions facing each other in the first direction.

In one embodiment, the second inductor pattern may include portions that face a plurality of the first inductor patterns.

According to one aspect of the present disclosure, it is possible to finely adjust magnetic coupling between the inductors.

### BRIEF DESCRIPTION OF THE DRAWINGS

FIG. 1 is a perspective view of an electronic component according to a first embodiment.

FIG. 2 is a view of the electronic component illustrated in FIG. 1 as viewed from an insulator side.

FIG. 3 is a view of the electronic component illustrated in FIG. 1 as viewed from a substrate side.

FIG. 4A is a side view of the electronic component.

FIG. 4B is an end view of the electronic component.

FIG. 5A is a view illustrating conductor patterns forming an LC filter portion.

FIG. 5B is a view illustrating conductor patterns forming the LC filter portion.

FIG. 5C is a view illustrating conductor patterns forming the LC filter portion.

FIG. 5D is a view illustrating conductor patterns forming the LC filter portion.

FIG. 5E is a view illustrating conductor patterns forming the LC filter portion.

FIG. 5F is a view illustrating conductor patterns forming the LC filter portion.

FIG. 5G is a view illustrating conductor patterns forming the LC filter portion.

FIG. 5H is a view illustrating conductor patterns forming the LC filter portion.

FIG. 6A is a cross-sectional view taken along line VI-VI in FIG. 2.

FIG. 6B is an enlarged view illustrating a part of FIG. 6A.

FIG. 7A is a cross-sectional view taken along line VII-VII in FIG. 2.

FIG. 7B is an enlarged view illustrating a part of FIG. 7A.

FIG. 8 is an equivalent circuit diagram of the electronic component.

FIG. 9A is a view illustrating the disposition of inductor patterns according to a modification example.

FIG. 9B is a view illustrating the disposition of inductor patterns according to the modification example.

FIG. 9C is a view illustrating the disposition of inductor patterns according to the modification example.

FIG. 10 is a perspective view of an electronic component according to a second embodiment.

FIG. 11 is a view of the electronic component illustrated in FIG. 10 as viewed from an insulator side.

FIG. 12A is a view illustrating conductor patterns forming an LC filter portion.

FIG. 12B is a view illustrating conductor patterns forming the LC filter portion.

FIG. 12C is a view illustrating conductor patterns forming the LC filter portion.

FIG. 12D is a view illustrating conductor patterns forming the LC filter portion.

FIG. 12E is a view illustrating conductor patterns forming the LC filter portion.

FIG. 12F is a view illustrating conductor patterns forming the LC filter portion.

FIG. 12G is a view illustrating conductor patterns forming the LC filter portion.

FIG. 12H is a view illustrating conductor patterns forming the LC filter portion.

FIG. 13 is a cross-sectional view taken along line XIII-XIII in FIG. 11.

FIG. 14 is an equivalent circuit diagram of the electronic component illustrated in FIG. 10.

FIG. 15A is a view illustrating an electronic component according to a third embodiment.

FIG. 15B is a cross-sectional view taken along line b-b in FIG. 15A.

FIG. 16 is an equivalent circuit diagram of the electronic component illustrated in FIG. 15A.

### DETAILED DESCRIPTION

Hereinafter, exemplary embodiments of the present disclosure will be described in detail with reference to the accompanying drawings. Incidentally, in the description of the drawings, the same or equivalent elements are denoted by the same reference signs, and duplicate descriptions will be omitted.

### First Embodiment

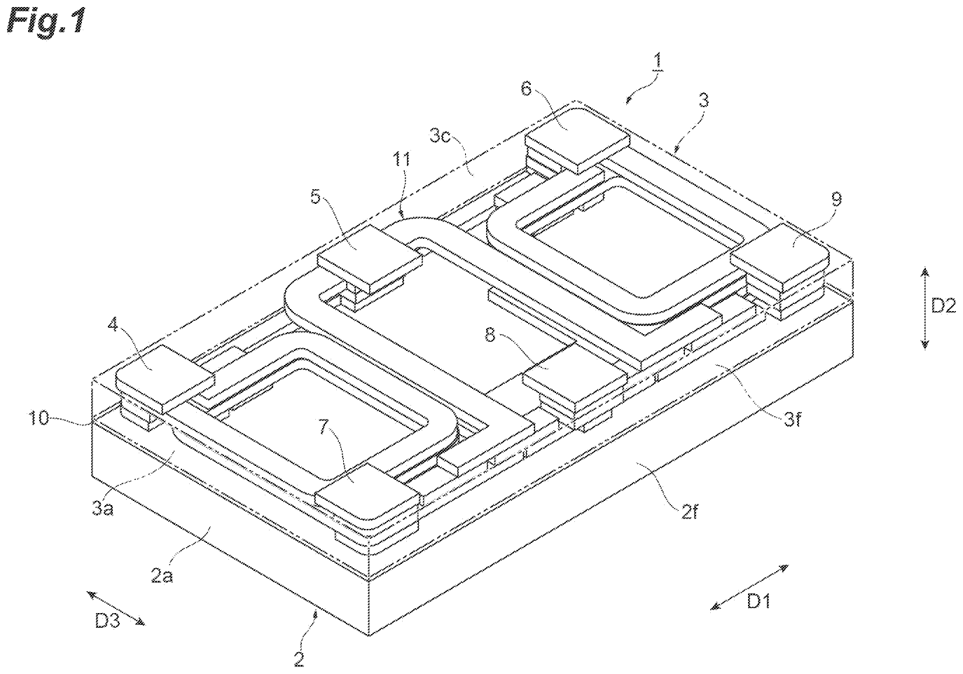

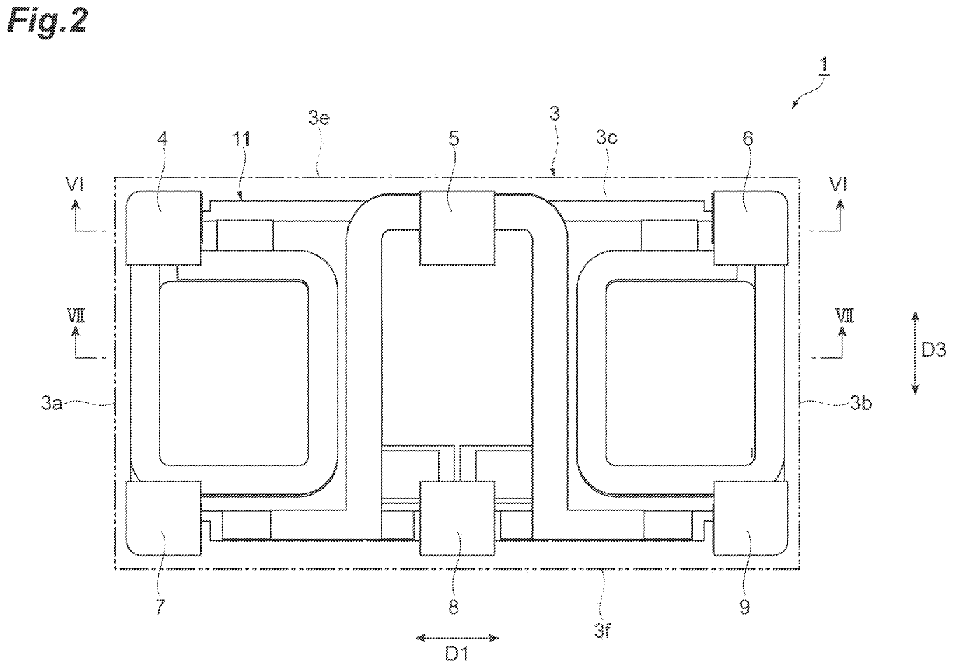

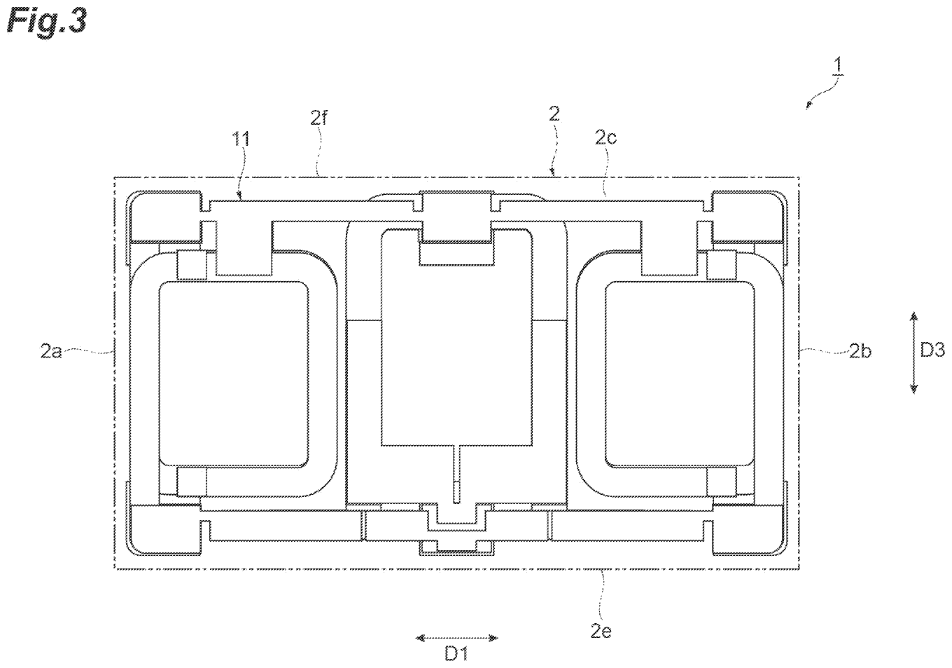

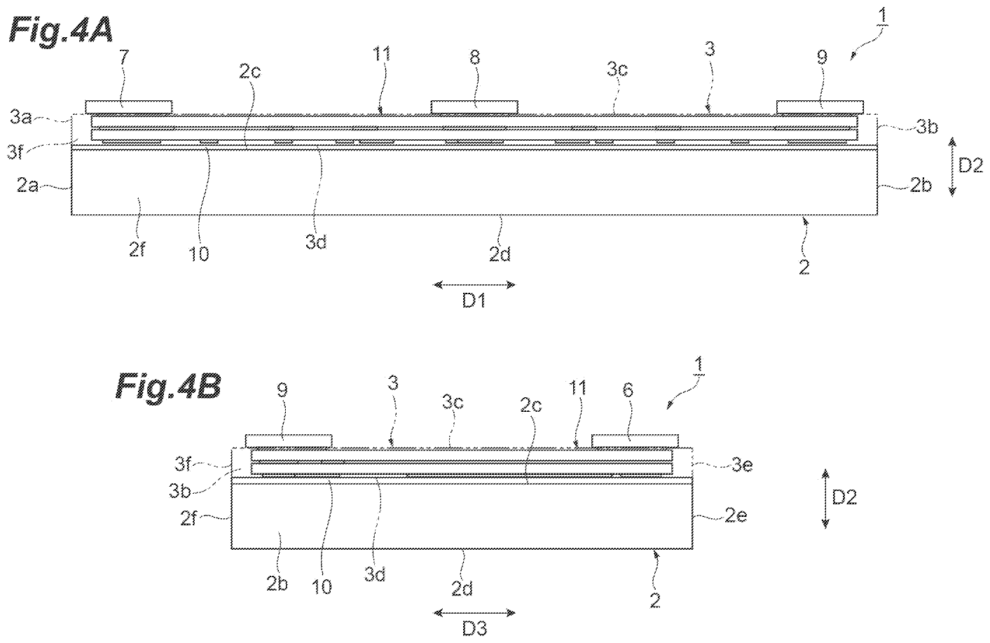

FIG. 1 is a perspective view of an electronic component according to a first embodiment. FIG. 2 is a view of the electronic component illustrated in FIG. 1 as viewed from an insulator side. FIG. 3 is a view of the electronic component illustrated in FIG. 1 as viewed from a substrate side. FIG. 4A is a side view of the electronic component, and FIG. 4B is an end view of the electronic component.

An electronic component 1 illustrated in FIG. 1 is an LC filter. The electronic component 1 is a so-called thin-film LC filter. As illustrated in FIGS. 1 and 2, the electronic component 1 includes a substrate 2; an insulator (element body) 3; and a first terminal electrode 4, a second terminal electrode 5, a third terminal electrode 6, a fourth terminal electrode 7, a fifth terminal electrode 8, and a sixth terminal electrode 9 disposed in the insulator 3.

The substrate 2 has a rectangular parallelepiped shape. Examples of the rectangular parallelepiped shape include a rectangular parallelepiped shape where corners and edges are chamfered, and a rectangular parallelepiped shape where corners and edges are rounded. The substrate 2 has a pair of end surfaces 2a and 2b facing each other, a pair of main surfaces 2c and 2d facing each other, and a pair of side surfaces 2e and 2f facing each other, as outer surfaces of the substrate 2.

A facing direction in which the pair of end surfaces 2a and 2b face each other is a first direction D1. A facing direction in which the pair of main surfaces 2c and 2d face each other is a second direction D2. A facing direction in which the pair of side surfaces 2e and 2f face each other is a third direction D3. In the present embodiment, the first direction D1 is a longitudinal direction of the substrate 2. The second direction D2 is a height direction of the substrate 2 and is orthogonal to the first direction D1. The third direction D3 is a width direction of the substrate 2 and is orthogonal to the first direction D1 and the second direction D2.

The pair of end surfaces 2a and 2b extend in the second direction D2 to connect between the pair of main surfaces 2c and 2d. The pair of end surfaces 2a and 2b also extend in the third direction D3. The pair of side surfaces 2e and 2f extend in the second direction D2 to connect between the pair of main surfaces 2c and 2d. The pair of side surfaces 2e and 2f also extend in the first direction D1.

The substrate 2 may be made of a material that generates little stress due to chemically and/or thermally stable characteristics, and that may form smooth surfaces. The material is not particularly limited; however, silicon single crystal, alumina, sapphire, aluminum nitride, MgO single crystal, SrTiO₃ single crystal, surface-oxidized silicon, glass, quartz, ferrite, and the like might be used.

The insulator 3 has a rectangular parallelepiped shape. The insulator 3 has a pair of end surfaces 3a and 3b facing each other, a pair of main surfaces 3c and 3d (i.e., first and second main surfaces) facing each other, and a pair of side surfaces 3e and 3f facing each other, as outer surfaces of the insulator 3. The pair of end surfaces 3a and 3b face each other in the first direction D1. The pair of main surfaces 3c and 3d face each other in the second direction D2. The pair of side surfaces 3e and 3f face each other in the third direction D3.

The pair of end surfaces 3a and 3b extend in the second direction D2 to connect between the pair of main surfaces 3c and 3d. The pair of end surfaces 3a and 3b also extend in the third direction D3. The pair of side surfaces 3e and 3f extend in the second direction D2 to connect between the pair of main surfaces 3c and 3d. The pair of side surfaces 3e and 3f also extend in the first direction D1. A dimension in the first direction D1 of the insulator 3 is the same as a dimension in the first direction D1 of the substrate 2. A dimension in the third direction D3 of the insulator 3 is the same as a dimension in the third direction D3 of the substrate 2.

Incidentally, regarding “being the same” in the present embodiment, in addition to being equal, values including a slight difference, manufacturing errors, or the like within a range set in advance may be considered to be the same. For example, when a plurality of values are within a range of ±5% of an average value of the plurality of values, the plurality of values are specified as being the same.

The insulator 3 is formed by stacking a plurality of insulator layers. The insulator layers may be made of an organic insulation material such as polyimide. The insulator layers are stacked in the second direction D2. Namely, the second direction D2 is a stacking direction. In the actual insulator 3, the plurality of insulator layers are integrated to such an extent that boundaries between the insulator layers cannot be visually distinguished.

The substrate 2 and the insulator 3 might be integrated as one device. The substrate 2 and the insulator 3 are disposed such that the main surface 2c and the main surface 3d face each other. A planarization layer 10 is disposed between the substrate 2 and the insulator 3. The planarization layer 10 is disposed between the main surface 2c of the substrate 2 and the main surface 3d of the insulator 3. Alumina, silicon oxide, or the like can be used as the planarization layer 10.

As illustrated in FIGS. 1 and 3, the first terminal electrode 4, the second terminal electrode 5, the third terminal electrode 6, the fourth terminal electrode 7, the fifth terminal electrode 8, and the sixth terminal electrode 9 are disposed on the main surface 3c of the insulator 3. The fourth terminal electrode 7 and the sixth terminal electrode 9 are input/output terminals. The first terminal electrode 4, the second terminal electrode 5, the third terminal electrode 6, and the fifth terminal electrode 8 are ground terminals.

The first terminal electrode 4, the second terminal electrode 5, the third terminal electrode 6, the fourth terminal electrode 7, the fifth terminal electrode 8, and the sixth terminal electrode 9 have a substantially rectangular shape in a plan view. Examples of the rectangular shape may include shapes where corners and edges are chamfered and shapes where corners and edges are rounded. The first terminal electrode 4, the third terminal electrode 6, the fourth terminal electrode 7, and the sixth terminal electrode 9 have a shape where one corner is rounded (curved).

The first terminal electrode 4 is disposed at a position toward the end surface 3a and toward the side surface 3e. The second terminal electrode 5 is disposed at a position between the end surface 3a and the end surface 3b and toward the side surface 3e. The third terminal electrode 6 is disposed at a position toward the end surface 3b and toward the side surface 3e. The fourth terminal electrode 7 is disposed at a position toward the end surface 3a and toward the side surface 3f. The fifth terminal electrode 8 is disposed at a position between the end surface 3a and the end surface 3b and toward the side surface 3f. The sixth terminal electrode 9 is disposed at a position toward the end surface 3b and toward the side surface 3f.

The first terminal electrode 4, the second terminal electrode 5, and the third terminal electrode 6 are disposed at predetermined intervals in the first direction D1. The fourth terminal electrode 7, the fifth terminal electrode 8, and the sixth terminal electrode 9 are disposed at predetermined intervals in the first direction D1. The first terminal electrode 4 and the fourth terminal electrode 7 are disposed at a predetermined interval in the third direction D3. The second terminal electrode 5 and the fifth terminal electrode 8 are disposed at a predetermined interval in the third direction D3. The third terminal electrode 6 and the sixth terminal electrode 9 are disposed at a predetermined interval in the third direction D3.

The first terminal electrode 4, the second terminal electrode 5, the third terminal electrode 6, the fourth terminal electrode 7, the fifth terminal electrode 8, and the sixth terminal electrode 9 are made of, for example, gold, nickel, copper, silver, or the like.

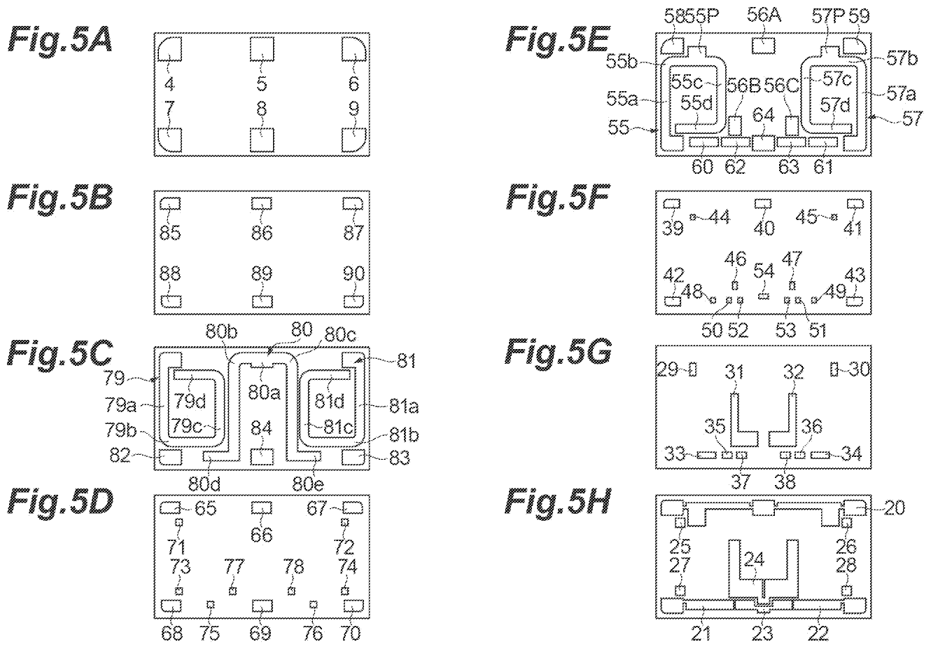

The electronic component 1 is such that an LC filter portion 11 is disposed inside the insulator 3. FIGS. 5A, 5B, 5C, 5D, 5E, 5F, 5G, and 5H are views illustrating conductor patterns forming the LC filter portion 11. In the electronic component 1, the conductor patterns are disposed in order of FIGS. 5H, 5G, 5F, 5E, 5D, 5C, 5B, and 5A from a substrate 2 side (main surface 3d side of the insulator 3). The conductor patterns include inductor patterns, capacitor patterns, and through-hole patterns. The conductor patterns can be made of, for example, copper. Incidentally, the through-hole patterns may be via patterns.

As illustrated in FIG. 5H, the LC filter portion 11 includes a conductor pattern 20, a conductor pattern 21, a conductor pattern 22, a conductor pattern 23, a conductor pattern 24, a conductor pattern 25, a conductor pattern 26, a conductor pattern 27, and a conductor pattern 28. The conductor patterns 20 to 28 are disposed on the planarization layer 10.

As illustrated in FIG. 5G, the LC filter portion 11 includes a capacitor pattern 29, a capacitor pattern 30, a capacitor pattern 31, a capacitor pattern 32, a capacitor pattern 33, a capacitor pattern 34, a capacitor pattern 35, a capacitor pattern 36, a capacitor pattern 37, and a capacitor pattern 38.

As illustrated in FIG. 5F, the LC filter portion 11 includes a through-hole pattern 39, a through-hole pattern 40, a through-hole pattern 41, a through-hole pattern 42, a through-hole pattern 43, a through-hole pattern 44, a through-hole pattern 45, a through-hole pattern 46, a through-hole pattern 47, a through-hole pattern 48, a through-hole pattern 49, a through-hole pattern 50, a through-hole pattern 51, a through-hole pattern 52, a through-hole pattern 53, and a through-hole pattern 54.

As illustrated in FIG. 5E, the LC filter portion 11 includes an inductor pattern (first inductor pattern) 55, conductor patterns 56A, 56B, and 56C, an inductor pattern (first inductor pattern) 57, a conductor pattern 58, a conductor pattern 59, a conductor pattern 60, a conductor pattern 61, a conductor pattern 62, a conductor pattern 63, and a conductor pattern 64. The inductor pattern 55 is disposed toward the end surface 2a in the first direction D1. The inductor pattern 57 is disposed toward the end surface 2b in the first direction D1.

As illustrated in FIG. 5D, the LC filter portion 11 includes a through-hole pattern 65, a through-hole pattern 66, a through-hole pattern 67, a through-hole pattern 68, a through-hole pattern 69, a through-hole pattern 70, a through-hole pattern 71, a through-hole pattern 72, a through-hole pattern 73, a through-hole pattern 74, a through-hole pattern 75, a through-hole pattern 76, a through-hole pattern 77, and a through-hole pattern 78.

As illustrated in FIG. 5C, the LC filter portion 11 includes an inductor pattern (first inductor pattern) 79, an inductor pattern (second inductor pattern) 80, an inductor pattern (first inductor pattern) 81, a conductor pattern 82, a conductor pattern 83, and a conductor pattern 84.

The inductor pattern 79 is disposed toward the end surface 2a in the first direction D1 (for example, the inductor pattern 79 is disposed closer to end surface 2a than end surface 2b). The inductor pattern 81 is disposed toward the end surface 2b in the first direction D1 (for example, the inductor pattern 81 is disposed closer to end surface 2b than end surface 2a). The inductor pattern 80 is disposed between the inductor pattern 79 and the inductor pattern 81 in the first direction D1. The inductor pattern 79, the inductor pattern 80, and the inductor pattern 81 are disposed side by side in the first direction D1 as viewed in the second direction D2. In the present embodiment, being disposed side by side means that when the inductor patterns are viewed in certain direction from the end surfaces 3a and 3b or the side surfaces 3e and 3f, two inductor patterns at least partially overlap each other (including overlapping portions).

As illustrated in FIG. 5B, the LC filter portion 11 includes a through-hole pattern 85, a through-hole pattern 86, a through-hole pattern 87, a through-hole pattern 88, a through-hole pattern 89, and a through-hole pattern 90.

As illustrated in FIG. 5A, the electronic component 1 includes the first terminal electrode 4, the second terminal electrode 5, the third terminal electrode 6, the fourth terminal electrode 7, the fifth terminal electrode 8, and the sixth terminal electrode 9.

As illustrated in FIG. 5E, the inductor pattern 55 includes a first pattern portion 55a extending along the third direction D3; a second pattern portion 55b connected to an end portion of the first pattern portion 55a and extending along the first direction D1; a third pattern portion 55c connected to an end portion of the second pattern portion 55b and extending along the third direction D3; and a fourth pattern portion 55d connected to an end portion of the third pattern portion 55c and extending along the first direction D1. The first pattern portion 55a is disposed toward the end surface 3a. The first pattern portion 55a and the third pattern portion 55c are separated from each other in the first direction D1. The second pattern portion 55b and the fourth pattern portion 55d are separated from each other in the third direction D3.

The inductor pattern 55 is provided with a pad 55P. The pad 55P protrudes from the second pattern portion 55b toward the side surface 3e. The pad 55P is located in a region between the first terminal electrode 4 and the second terminal electrode 5 as viewed in the second direction D2. The pad 55P is connected to the capacitor pattern 29 through the through-hole pattern 44.

The inductor pattern 57 includes a first pattern portion 57a extending along the third direction D3; a second pattern portion 57b connected to an end portion of the first pattern portion 57a and extending along the first direction D1; a third pattern portion 57c connected to an end portion of the second pattern portion 57b and extending along the third direction D3; and a fourth pattern portion 57d connected to an end portion of the third pattern portion 57c and extending along the first direction D1. The first pattern portion 57a is disposed toward the end surface 3b. The first pattern portion 57a and the third pattern portion 57c are separated from each other in the first direction D1. The second pattern portion 57b and the fourth pattern portion 57d are separated from each other in the third direction D3.

The inductor pattern 57 is provided with a pad 57P. The pad 57P protrudes from the second pattern portion 57b toward the side surface 3e. The pad 57P is located in a region between the second terminal electrode 5 and the third terminal electrode 6 as viewed in the second direction D2. The pad 57P is connected to the capacitor pattern 30 through the through-hole pattern 45.

As illustrated in FIG. 5C, the inductor pattern 79 includes a first pattern portion 79a extending along the third direction D3; a second pattern portion 79b connected to an end portion of the first pattern portion 79a and extending along the first direction D1; a third pattern portion 79c connected to an end portion of the second pattern portion 79b and extending along the third direction D3; and a fourth pattern portion 79d connected to an end portion of the third pattern portion 79c and extending along the first direction D1. The first pattern portion 79a is disposed toward the end surface 3a. The first pattern portion 79a and the third pattern portion 79c are separated from each other in the first direction D1. The second pattern portion 79b and the fourth pattern portion 79d are separated from each other in the third direction D3.

The inductor pattern 80 includes a first pattern portion 80a extending along the first direction D1; a second pattern portion 80b connected to one end portion of the first pattern portion 80a and extending along the third direction D3; a third pattern portion 80c connected to the other end portion of the first pattern portion 80a and extending along the third direction D3; a fourth pattern portion 80d connected to an end portion of the second pattern portion 80b and extending along the first direction D1; and a fifth pattern portion 80e connected to an end portion of the third pattern portion 80c and extending along the first direction D1. The second pattern portion 80b and the third pattern portion 80c are separated from each other in the first direction D1.

The inductor pattern 81 includes a first pattern portion 81a extending along the third direction D3; a second pattern portion 81b connected to an end portion of the first pattern portion 81a and extending along the first direction D1; a third pattern portion 81c connected to an end portion of the second pattern portion 81b and extending along the third direction D3; and a fourth pattern portion 81d connected to an end portion of the third pattern portion 81c and extending along the first direction D1. The first pattern portion 81a is disposed toward the end surface 3b. The first pattern portion 81a and the third pattern portion 81c are separated from each other in the first direction D1. The second pattern portion 81b and the fourth pattern portion 81d are separated from each other in the third direction D3.

The through-hole pattern 39 connects the conductor pattern 20 and the conductor pattern 58. The through-hole pattern 40 connects the conductor pattern 20 and the conductor pattern 56A. The through-hole pattern 41 connects the conductor pattern 20 and the conductor pattern 59. The through-hole pattern 42 connects the conductor pattern 21 and the inductor pattern 55. The through-hole pattern 43 connects the conductor pattern 22 and the inductor pattern 57. The through-hole pattern 44 connects the capacitor pattern 29 and the pad 55P of the inductor pattern 55. The through-hole pattern 45 connects the capacitor pattern 30 and the pad 57P of the inductor pattern 57.

The through-hole pattern 46 connects the capacitor pattern 31 and the conductor pattern 56B. The through-hole pattern 47 connects the capacitor pattern 32 and the conductor pattern 56C. The through-hole pattern 48 connects the capacitor pattern 33 and the conductor pattern 60. The through-hole pattern 49 connects the capacitor pattern 34 and the conductor pattern 61. The through-hole pattern 50 connects the capacitor pattern 35 and the conductor pattern 62. The through-hole pattern 51 connects the capacitor pattern 36 and the conductor pattern 63. The through-hole pattern 52 connects the capacitor pattern 37 and the conductor pattern 62. The through-hole pattern 53 connects the capacitor pattern 38 and the conductor pattern 63. The through-hole pattern 54 connects the conductor pattern 24 and the conductor pattern 64.

The through-hole pattern 65 connects the conductor pattern 58 and the inductor pattern 79. The through-hole pattern 66 connects the conductor pattern 56A and the inductor pattern 80. The through-hole pattern 67 connects the conductor pattern 59 and the inductor pattern 81. The through-hole pattern 68 connects the inductor pattern 55 and the conductor pattern 82. The through-hole pattern 69 connects the conductor pattern 64 and the conductor pattern 84. The through-hole pattern 70 connects the inductor pattern 57 and the conductor pattern 83. The through-hole pattern 71 connects the inductor pattern 55 and the inductor pattern 79.

The through-hole pattern 72 connects the inductor pattern 57 and the inductor pattern 81. The through-hole pattern 73 connects the inductor pattern 55 and the inductor pattern 79. The through-hole pattern 74 connects the inductor pattern 57 and the inductor pattern 81. The through-hole pattern 75 connects the conductor pattern 60 and the inductor pattern 80. The through-hole pattern 76 connects the conductor pattern 61 and the inductor pattern 80. The through-hole pattern 77 connects the conductor pattern 56B and the inductor pattern 80. The through-hole pattern 78 connects the conductor pattern 56C and the inductor pattern 80.

The through-hole pattern 85 connects the inductor pattern 79 and the first terminal electrode 4. The through-hole pattern 86 connects the inductor pattern 80 and the second terminal electrode 5. The through-hole pattern 87 connects the inductor pattern 81 and the third terminal electrode 6. The through-hole pattern 88 connects the conductor pattern 82 and the fourth terminal electrode 7. The through-hole pattern 89 connects the conductor pattern 84 and the fifth terminal electrode 8. The through-hole pattern 90 connects the conductor pattern 83 and the sixth terminal electrode 9.

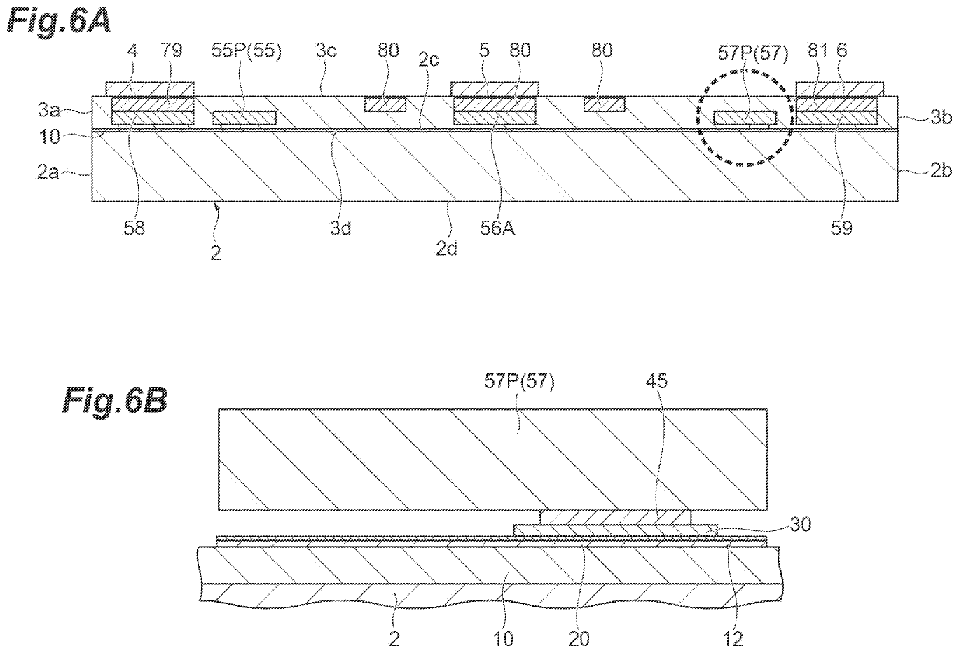

FIG. 6A is a cross-sectional view taken along line VI-VI in FIG. 2, and FIG. 6B is an enlarged view illustrating a part of FIG. 6A. As illustrated in FIG. 6B, a dielectric layer 12 is disposed between the conductor pattern 20 and the capacitor pattern 30. The dielectric layer 12 is also disposed between the conductor patterns 20 to 24 and the capacitor patterns 29 and 31 to 38. The dielectric layer 12 may be made of, for example, an inorganic insulation material including a ferroelectric material, a paraelectric material such as silicon nitride or silicon oxide, or the like.

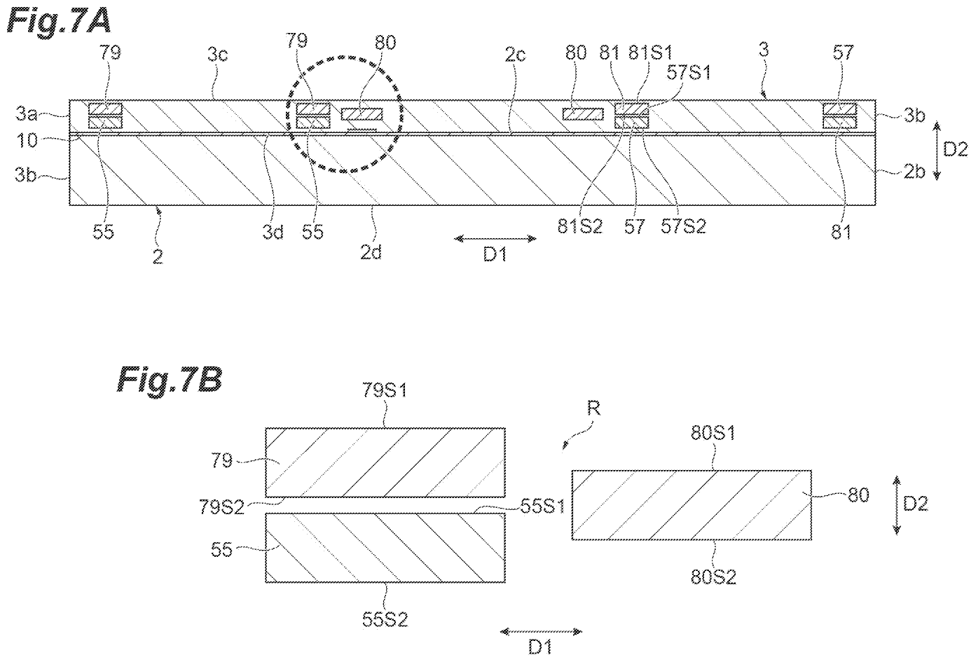

FIG. 7A is a cross-sectional view taken along line VII-VII in FIG. 2, and FIG. 7B is an enlarged view illustrating a part of FIG. 7A. In the present embodiment, the inductor pattern 55, the inductor pattern 57, the inductor pattern 79, the inductor pattern 80, and the inductor pattern 81 have the same thickness (dimension in the second direction D2).

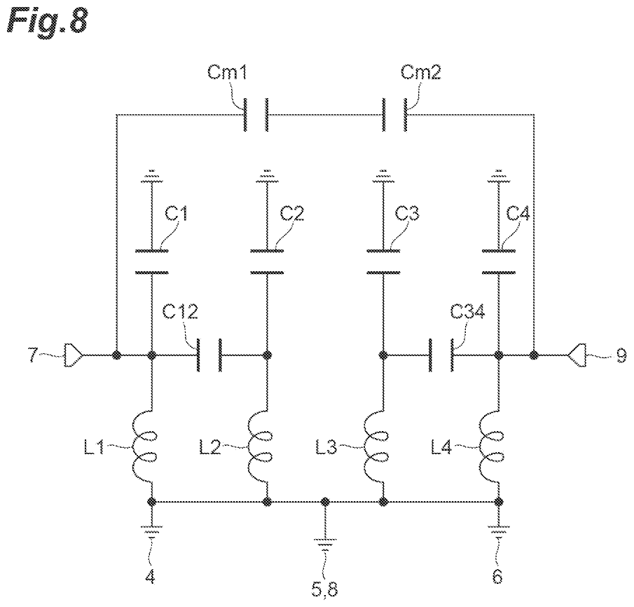

As illustrated in FIG. 7A, the inductor pattern 80 and both the inductor pattern 55 and the inductor pattern 79 are disposed side by side in the first direction D1. Specifically, the second pattern portion 80b of the inductor pattern 80 and both the third pattern portion 55c of the inductor pattern 55 and the third pattern portion 79c of the inductor pattern 79 are disposed side by side in the first direction D1. Namely, a first inductor L1 including the inductor pattern 55 and the inductor pattern 79 (refer to FIG. 8) and a second inductor L2 including the inductor pattern 80 (refer to FIG. 8) are disposed adjacent to each other in the first direction D1.

The first inductor L1 and the second inductor L2 include different numbers of patterns in an adjacent region R (refer to FIG. 7B). Referring to the FIG. 7B, two inductor patterns (inductor pattern 55 and inductor pattern 79) of the first inductor L1, one inductor pattern (inductor pattern 80) of the second inductor L2, are disposed in the region R where the first inductor L1 and the second inductor L2 are adjacent to each other. The first inductor L1 and the second inductor L2 are magnetically coupled in the adjacent region R. In some embodiment, specifically, the inductor pattern 80 and both the inductor pattern 55 and the inductor pattern 79 may be magnetically coupled in the region R.

The inductor pattern 80 and both the inductor pattern 57 and the inductor pattern 81 are disposed side by side in the first direction D1. Specifically, the third pattern portion 80c of the inductor pattern 80 and both the third pattern portion 57c of the inductor pattern 57 and the third pattern portion 81c of the inductor pattern 81 are disposed side by side in the first direction D1. Namely, a fourth inductor L4 including the inductor pattern 57 and the inductor pattern 81 (refer to FIG. 8) and a third inductor L3 including the inductor pattern 80 (refer to FIG. 8) are disposed adjacent to each other in the first direction D1.

The fourth inductor L4 and the third inductor L3 include different numbers of patterns in the adjacent region R. In the region R where the fourth inductor L4 and the third inductor L3 are adjacent to each other, two inductor patterns (inductor pattern 57 and inductor pattern 81) of the fourth inductor L4, and one inductor pattern (inductor pattern 80) of the third inductor L3, are disposed. The fourth inductor L4 and the third inductor L3 are magnetically coupled in the adjacent region R. In some embodiment, specifically, the inductor pattern 80 and both the inductor pattern 57 and the inductor pattern 81 might be magnetically coupled in the region R.

As illustrated in FIG. 7B, the inductor pattern 55 has an upper surface (first surface) 55S1 and a lower surface (second surface) 55S2 facing each other in the second direction D2. The upper surface 55S1 is located toward the main surface (one main surface) 3c (for example, the upper surface 55S1 is disposed closer to 3c than 3d). The lower surface 55S2 is located toward the main surface (the other main surface) 3d (for example, the lower surface 55S2 is disposed closer to 3d than 3c). The inductor pattern 79 has an upper surface (first surface) 79S1 and a lower surface (second surface) 79S2 facing each other in the second direction D2. The upper surface 79S1 is located toward the main surface 3c (closer to the main surface 3c than 3d). The lower surface 79S2 is located toward the main surface 3d (closer to the main surface 3d than 3c). The inductor pattern 80 has an upper surface (third surface) 80S1 and a lower surface (fourth surface) 80S2 facing each other in the second direction D2. The upper surface 80S1 is located toward the main surface 3c (closer to the main surface 3c than 3d). The lower surface 80S2 is located toward the main surface 3d (closer to the main surface 3d than 3c). The upper surface 5551 and the lower surface 55S2, the upper surface 79S1 and the lower surface 79S2, and the upper surface 80S1 and the lower surface 80S2 may be, for example, flat surfaces.

The upper surface 55S1 and the lower surface 55S2 of the inductor pattern 55 and the upper surface 80S1 and the lower surface 80S2 of the inductor pattern 80 are at different height positions in the second direction D2. Specifically, the upper surface 55S1 of the inductor pattern 55 is located closer to the main surface 3d side of the insulator 3 in the second direction D2 than the upper surface 80S1 of the inductor pattern 80. In other words, the upper surface 80S1 of the inductor pattern 80 is located closer to a main surface 3c side of the insulator 3 in the second direction D2 than the upper surface 55S1 of the inductor pattern 55. The lower surface 55S2 of the inductor pattern 55 is located closer to the main surface 3d side of the insulator 3 in the second direction D2 than the lower surface 80S2 of the inductor pattern 80. In other words, the lower surface 80S2 of the inductor pattern 80 is located closer to the main surface 3c side of the insulator 3 in the second direction D2 than the lower surface 55S2 of the inductor pattern 55.

The upper surface 79S1 and the lower surface 79S2 of the inductor pattern 79 and the upper surface 80S1 and the lower surface 80S2 of the inductor pattern 80 are at different height positions in the second direction D2. Specifically, the upper surface 79S1 of the inductor pattern 79 is located closer to the main surface 3c side of the insulator 3 in the second direction D2 than the upper surface 80S1 of the inductor pattern 80. In other words, the upper surface 80S1 of the inductor pattern 80 is located closer to the main surface 3d side of the insulator 3 in the second direction D2 than the upper surface 79S1 of the inductor pattern 79. The lower surface 79S2 of the inductor pattern 79 is located closer to the main surface 3c side of the insulator 3 in the second direction D2 than the lower surface 80S2 of the inductor pattern 80. In other words, the lower surface 80S2 of the inductor pattern 80 is located closer to the main surface 3d side of the insulator 3 in the second direction D2 than the lower surface 79S2 of the inductor pattern 79.

The inductor pattern 55 and the inductor pattern 80 include portions facing each other in the first direction D1. The inductor pattern 55 and the inductor pattern 80 at least partially overlap each other as viewed in the third direction D3. The inductor pattern 79 and the inductor pattern 80 include portions facing each other in the first direction D1. The inductor pattern 79 and the inductor pattern 80 at least partially overlap each other in the second direction D2 as viewed in the third direction D3. The inductor pattern 80 includes portions that face both the inductor pattern 55 and the inductor pattern 79 in the first direction D1.

As illustrated in FIG. 7A, the inductor pattern 57 has an upper surface 57S1 and a lower surface 57S2 facing each other in the second direction D2. The upper surface 57S1 is located toward the main surface 3c (closer to the main surface 3c than 3d). The lower surface 57S2 is located toward the main surface 3d (closer to the main surface 3d than 3c). The inductor pattern 81 has an upper surface 81S1 and a lower surface 81S2 facing each other in the second direction D2. The upper surface 81S1 is located toward the main surface 3c (closer to the main surface 3c than 3d). The lower surface 81S2 is located toward the main surface 3d (closer to the main surface 3d than 3c). The upper surface 57S1 and the lower surface 57S2, and the upper surface 81S1 and the lower surface 81S2 may be, for example, flat surfaces.

The upper surface 57S1 and the lower surface 57S2 of the inductor pattern 57 and the upper surface 80S1 and the lower surface 80S2 of the inductor pattern 80 are at different height positions in the second direction D2. Specifically, the upper surface 57S1 of the inductor pattern 57 is located closer to the main surface 3d side of the insulator 3 in the second direction D2 than the upper surface 80S1 of the inductor pattern 80. In other words, the upper surface 80S1 of the inductor pattern 80 is located closer to the main surface 3c side of the insulator 3 in the second direction D2 than the upper surface 57S1 of the inductor pattern 57. The lower surface 57S2 of the inductor pattern 57 is located closer to the main surface 3d side of the insulator 3 in the second direction D2 than the lower surface 80S2 of the inductor pattern 80. In other words, the lower surface 80S2 of the inductor pattern 80 is located closer to the main surface 3c side of the insulator 3 in the second direction D2 than the lower surface 57S2 of the inductor pattern 57.

The upper surface 81S1 and the lower surface 81S2 of the inductor pattern 81 and the upper surface 80S1 and the lower surface 80S2 of the inductor pattern 80 are at different height positions in the second direction D2. Specifically, the upper surface 81S1 of the inductor pattern 81 is located closer to the main surface 3c side of the insulator 3 in the second direction D2 than the upper surface 80S1 of the inductor pattern 80. In other words, the upper surface 80S1 of the inductor pattern 80 is located closer to the main surface 3d side of the insulator 3 in the second direction D2 than the upper surface 81S1 of the inductor pattern 81. The lower surface 81S2 of the inductor pattern 81 is located closer to the main surface 3c side of the insulator 3 in the second direction D2 than the lower surface 80S2 of the inductor pattern 80. In other words, the lower surface 80S2 of the inductor pattern 80 is located closer to the main surface 3d side of the insulator 3 in the second direction D2 than the lower surface 81S2 of the inductor pattern 81.

The inductor pattern 57 and the inductor pattern 80 include portions facing each other in the first direction D1. The inductor pattern 57 and the inductor pattern 80 at least partially overlap each other as viewed in the third direction D3. The inductor pattern 81 and the inductor pattern 80 include portions facing each other in the first direction D1. The inductor pattern 81 and the inductor pattern 80 at least partially overlap each other in the second direction D2 as viewed in the third direction D3. The inductor pattern 80 includes portions that face both the inductor pattern 57 and the inductor pattern 81 in the first direction D1.

As illustrated in FIG. 8, the electronic component 1 includes the first inductor L1, the second inductor L2, the third inductor L3, the fourth inductor L4, a first capacitor C1, a second capacitor C2, a third capacitor C3, a fourth capacitor C4, a fifth capacitor C12, a sixth capacitor C34, a seventh capacitor Cm1, and an eighth capacitor Cm2.

The first inductor L1 includes the inductor pattern 55 and the inductor pattern 79. The second inductor L2 includes the inductor pattern 80. The third inductor L3 includes the inductor pattern 80. The fourth inductor L4 includes the inductor pattern 57 and the inductor pattern 81. The first inductor L1 and the fourth inductor L4 both include two inductor patterns. The second inductor L2 and the third inductor L3 both include one inductor pattern.

The first capacitor C1 is formed of the conductor pattern 20 and the capacitor pattern 29. The second capacitor C2 is formed of the conductor pattern 24 and the capacitor pattern 31. The third capacitor C3 is formed of the conductor pattern 24 and the capacitor pattern 32. The fourth capacitor C4 is formed of the conductor pattern 20 and the capacitor pattern 30.

The fifth capacitor C12 is formed of the conductor pattern 21 and the capacitor pattern 33. The sixth capacitor C34 is formed of the conductor pattern 22 and the capacitor pattern 34. The seventh capacitor Cm1 is formed of the conductor patterns 21 and 23 and the capacitor patterns 35 and 37. The eighth capacitor Cm2 is formed of the conductor patterns 22 and 23 and the capacitor patterns 36 and 38.

The first inductor L1 and the first capacitor C1 form a first LC resonator. The second inductor L2 and the second capacitor C2 form a second LC resonator. The third inductor L3 and the third capacitor C3 form a third LC resonator. The fourth inductor L4 and the fourth capacitor C4 form a fourth LC resonator.

Subsequently, a method for manufacturing the electronic component 1 will be described. In the manufacturing process of the electronic component 1, a large number of a plurality of the electronic components 1 are obtained using an assembly substrate; however, a manufacturing process to be described below focuses on a description of a manufacturing process of one electronic component 1.

First, the planarization layer 10 is formed on the substrate 2 using a sputtering method or the like, and a surface of the planarization layer 10 is smoothed by performing grinding or mirror-finishing treatment such as a CMP. Subsequently, a resist layer is spin-coated on the surface of the planarization layer 10, and then the resist layer is patterned to correspond to the shapes of the conductor patterns 20 to 28. In this state, a plating layer is formed by performing electroplating. Then, the conductor patterns 20 to 28 are formed by removing the resist layer.

Subsequently, the dielectric layer 12 is formed on the conductor patterns 20 to 24. As a method for forming the dielectric layer 12, a sputtering method, a plasma CVD method, an MOCVD method, a sol gel method, an electron beam evaporation method, or the like can be used.

Subsequently, the capacitor patterns 29 to 34 are formed on the conductor patterns 20 to 24 with the dielectric layer 12 sandwiched therebetween by using the same method as the method for forming the conductor patterns 20 to 28. Next, a first insulation layer is formed, and opening portions corresponding to the through-hole patterns 39 to 51 are formed in the first insulation layer by patterning the first insulation layer. Subsequently, a resist layer is spin-coated on the first insulation layer, and then the resist layer is patterned to correspond to the shapes of the inductor pattern 55, the conductor patterns 56A, 56B, and 56C, the inductor pattern 57, and the conductor patterns 58 to 64. In this state, a plating layer is formed by performing electroplating. Then, the through-hole patterns 39 to 51, the inductor pattern 55, the conductor patterns 56A, 56B, and 56C, the inductor pattern 57, and the conductor patterns 58 to 64 are formed by removing the resist layer.

Subsequently, a second insulation layer is formed, and opening portions corresponding to the through-hole patterns 65 to 78 are formed in the second insulation layer by patterning the second insulation layer. Next, a resist layer is spin-coated on the second insulation layer, and then the resist layer is patterned to correspond to the shape of the inductor pattern 80. In this state, a recessed portion is formed in the second insulation layer by performing etching. Then, a plating layer is formed by performing electroplating at a location where the recessed portion is formed in the second insulation layer. Then, the inductor pattern 80 is formed by removing the resist layer. In such a manner, the lower surface 80S2 of the inductor pattern 80 and the lower surface 79S2 of the inductor pattern 79 can be formed at different positions in the second direction D2 by forming the inductor pattern 80 in the recessed portion of the second insulation layer.

Subsequently, a resist layer is spin-coated on the second insulation layer, and then the resist layer is patterned to correspond to the shapes of the inductor pattern 79, the inductor pattern 81, and the conductor patterns 82 to 84. In this state, a plating layer is formed by performing electroplating. Then, the through-hole patterns 65 to 78, the inductor pattern 79, the inductor pattern 81, and the conductor patterns 82 to 84 are formed by removing the resist layer.

Subsequently, a third insulation layer is formed, and opening portions corresponding to the through-hole patterns 85 to 90 are formed in the third insulation layer by patterning the third insulation layer. Subsequently, a resist layer is spin-coated on the third insulation layer, and then the resist layer is patterned to correspond to the shapes of the first terminal electrode 4, the second terminal electrode 5, the third terminal electrode 6, the fourth terminal electrode 7, the fifth terminal electrode 8, and the sixth terminal electrode 9. In this state, a plating layer is formed by performing electroplating. Then, the through-hole patterns 85 to 90, the first terminal electrode 4, the second terminal electrode 5, the third terminal electrode 6, the fourth terminal electrode 7, the fifth terminal electrode 8, and the sixth terminal electrode 9 are formed by removing the resist layer. As described above, the electronic component 1 is manufactured.

As described above, in the electronic component 1 according to the present embodiment, in the region R where the first inductor L1 and the second inductor L2 are adjacent to each other in the first direction D1, at least one of the positions in the second direction D2 of the upper surface 79S1 of the inductor pattern 79 and the upper surface 80S1 of the inductor pattern 80 and the positions in the second direction D2 of the lower surface 79S2 of the inductor pattern 79 and the lower surface 80S2 of the inductor pattern 80 are different. In such a manner, in the region R where the first inductor L1 and the second inductor L2 are adjacent to each other, namely, in portions that are magnetically coupled, when the positions of the upper surface 79S1 of the inductor pattern 79 and the upper surface 80S1 of the inductor pattern 80 and/or the positions of the lower surface 79S2 of the inductor pattern 79 and the lower surface 80S2 of the inductor pattern 80 are differentiated, the degree of coupling in magnetic coupling between the first inductor L1 and the second inductor L2 changes. In such a manner, in the electronic component 1, magnetic coupling between the first inductor L1 and the second inductor L2 can be adjusted without depending on the thicknesses of the insulation layers. Therefore, in the electronic component 1, magnetic coupling between the inductors can be finely adjusted.

In the electronic component 1 according to the present embodiment, in the region R where the first inductor L1 and the second inductor L2 are adjacent to each other, the number of the inductor patterns 55 and 79 is different from the number of the inductor patterns 80. In such a manner, magnetic coupling between the first inductor L1 and the second inductor L2 can be adjusted by differentiating the number of the inductor patterns 55 and 79 and the number of the inductor patterns 80. In addition, in the electronic component 1, in the region R where the fourth inductor L4 and the third inductor L3 are adjacent to each other, the number of the inductor patterns 57 and 81 is different from the number of the inductor patterns 80. In such a manner, magnetic coupling between the fourth inductor L4 and the third inductor L3 can be adjusted by differentiating the number of the inductor patterns 57 and 81 and the number of the inductor patterns 80.

In the electronic component 1 according to the present embodiment, in the region R where the first inductor L1 and the second inductor L2 are adjacent to each other, the inductor patterns 55 and 79 and the inductor pattern 80 include portions facing each other in the first direction D1. In this configuration, since the inductor patterns 55 and 79 and the inductor pattern 80 include the facing portions, the degree of coupling in magnetic coupling between the first inductor L1 and the second inductor L2 can be finely adjusted. In addition, in the electronic component 1, in the region R where the fourth inductor L4 and the third inductor L3 are adjacent to each other, the inductor patterns 57 and 81 and the inductor pattern 80 include portions facing each other in the first direction D1. In this configuration, since the inductor patterns 57 and 81 and the inductor pattern 80 include the facing portions, the degree of coupling in magnetic coupling between the fourth inductor L4 and the third inductor L3 can be finely adjusted.

In the electronic component 1 according to the present embodiment, the inductor pattern 80 includes portions that face the inductor pattern 55 and the inductor pattern 79. In this configuration, the degree of coupling in magnetic coupling between the first inductor L1 and the second inductor L2 can be increased. In addition, the inductor pattern 80 includes portions that face the inductor pattern 57 and the inductor pattern 81. In this configuration, the degree of coupling in magnetic coupling between the fourth inductor L4 and the third inductor L3 can be increased.

### Second Embodiment

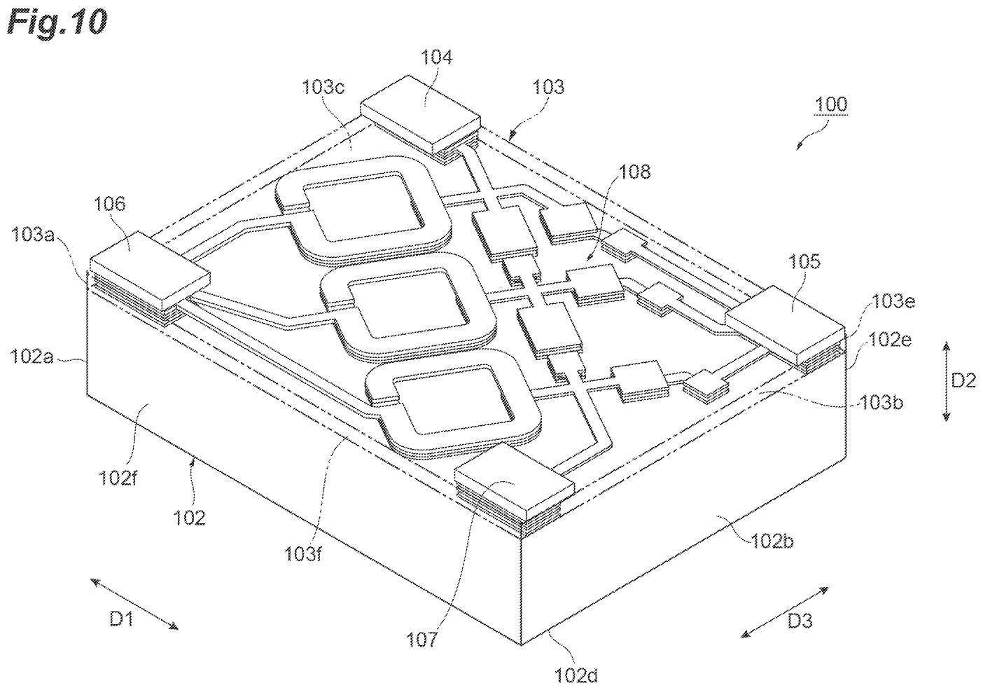

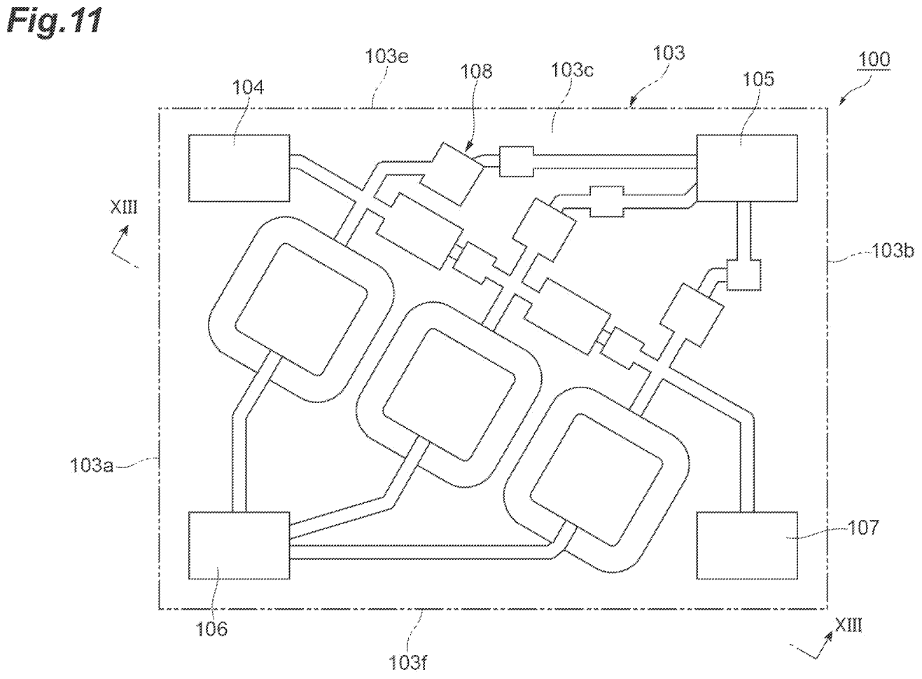

Subsequently, a second embodiment will be described. FIG. 10 is a perspective view of an electronic component according to a second embodiment. FIG. 11 is a view of the electronic component illustrated in FIG. 10 as viewed from an insulator side.

An electronic component 100 illustrated in FIG. 10 is an LC filter. The electronic component 100 is a so-called thin-film LC filter. As illustrated in FIGS. 10 and 11, the electronic component 100 includes a substrate 102; an insulator (element body) 103; and a first terminal electrode 104, a second terminal electrode 105, a third terminal electrode 106, and a fourth terminal electrode 107 disposed in the insulator 103.

The substrate 102 has the same configuration as that of the substrate 2 of the electronic component 1. The substrate 102 has a pair of end surfaces 102a and 102b facing each other, a pair of main surfaces 102c and 102d facing each other, and a pair of side surfaces 102e and 102f facing each other, as outer surfaces of the substrate 102. A facing direction in which the pair of end surfaces 102a and 102b face each other is the first direction D1. A facing direction in which the pair of main surfaces 102c and 102d face each other is the second direction D2. A facing direction in which the pair of side surfaces 102e and 102f face each other is the third direction D3.

The insulator 103 has the same configuration as that of the insulator 3 of the electronic component 1. The insulator 103 has a rectangular parallelepiped shape. The insulator 103 has a pair of end surfaces 103a and 103b facing each other, a pair of main surfaces 103c and 103d facing each other, and a pair of side surfaces 103e and 103f facing each other, as outer surfaces of the insulator 103. The pair of end surfaces 103a and 103b face each other in the first direction D1. The pair of main surfaces 103c and 103d face each other in the second direction D2. The pair of side surfaces 103e and 103f face each other in the third direction D3.

The substrate 102 and the insulator 103 are integrally provided. The substrate 102 and the insulator 103 are disposed such that the main surface 102c and the main surface 103d face each other. A planarization layer 109 is disposed between the substrate 102 and the insulator 103. The planarization layer 109 is disposed between the main surface 102c of the substrate 102 and the main surface 103d of the insulator 103. Alumina, silicon oxide, or the like can be used as the planarization layer 109.

The first terminal electrode 104, the second terminal electrode 105, the third terminal electrode 106, and the fourth terminal electrode 107 are disposed on the main surface 103c of the insulator 103. The first terminal electrode 104 and the fourth terminal electrode 107 are input/output terminals. The second terminal electrode 105 and the third terminal electrode 106 are ground terminals.

The first terminal electrode 104, the second terminal electrode 105, the third terminal electrode 106, and the fourth terminal electrode 107 have a substantially rectangular shape in a plan view. Examples of the rectangular shape include shapes where corners and edges are chamfered and shapes where corners and edges are rounded.

The first terminal electrode 104 is disposed at a position toward the end surface 103a and toward the side surface 103e. The second terminal electrode 105 is disposed at a position toward the end surface 103b and toward the side surface 103e. The third terminal electrode 106 is disposed at a position toward the end surface 103a and toward the side surface 103f. The fourth terminal electrode 107 is disposed at a position toward the end surface 103b and toward the side surface 103f.

The first terminal electrode 104 and the second terminal electrode 105 are disposed at a predetermined interval in the first direction D1. The third terminal electrode 106 and the fourth terminal electrode 107 are disposed at a predetermined interval in the first direction D1. The first terminal electrode 104 and the third terminal electrode 106 are disposed at a predetermined interval in the third direction D3. The second terminal electrode 105 and the fourth terminal electrode 107 are disposed at a predetermined interval in the third direction D3.

The first terminal electrode 104, the second terminal electrode 105, the third terminal electrode 106, and the fourth terminal electrode 107 are made of, for example, gold, nickel, copper, silver, or the like.

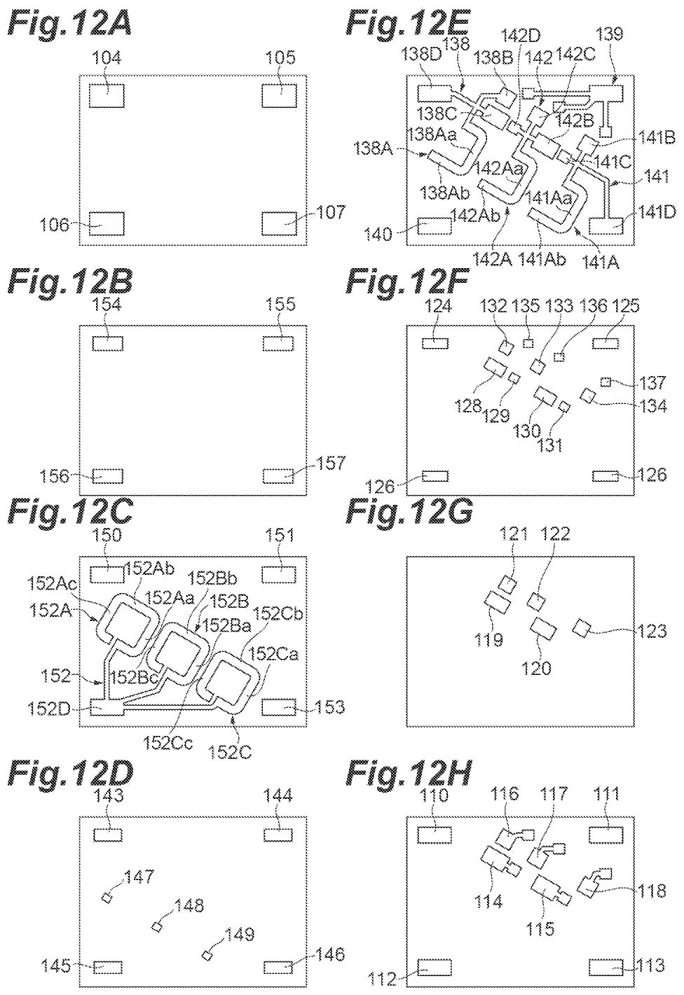

The electronic component 100 is such that an LC filter portion 108 is disposed inside the insulator 103. FIGS. 12A, 12B, 12C, 12D, 12E, 12F, 12G, and 12H are views illustrating conductor patterns forming the LC filter portion 108. In the electronic component 100, the conductor patterns are disposed in order of FIGS. 12H, 12G, 12F, 12E, 12D, 12C, 12B, and 12A from a substrate 102 side (main surface 103d side of the insulator 103). The conductor patterns include inductor patterns, capacitor patterns, and through-hole patterns. The conductor patterns can be made of, for example, copper.

As illustrated in FIG. 12H, the LC filter portion 108 includes a conductor pattern 110, a conductor pattern 111, a conductor pattern 112, a conductor pattern 113, a capacitor pattern 114, a capacitor pattern 115, a capacitor pattern 116, a capacitor pattern 117, and a capacitor pattern 118. The conductor patterns 110 to 113 and the capacitor patterns 114 to 118 are disposed on the planarization layer 109.

As illustrated in FIG. 12G, the LC filter portion 108 includes a capacitor pattern 119, a capacitor pattern 120, a capacitor pattern 121, a capacitor pattern 122, and a capacitor pattern 123.

As illustrated in FIG. 12F, the LC filter portion 108 includes a through-hole pattern 124, a through-hole pattern 125, a through-hole pattern 126, a through-hole pattern 127, a through-hole pattern 128, a through-hole pattern 129, a through-hole pattern 130, a through-hole pattern 131, a through-hole pattern 132, a through-hole pattern 133, a through-hole pattern 134, a through-hole pattern 135, a through-hole pattern 136, and a through-hole pattern 137.

As illustrated in FIG. 12E, the LC filter portion 108 includes a conductor pattern 138, a conductor pattern 139, a conductor pattern 140, a conductor pattern 141, and a conductor pattern 142.

As illustrated in FIG. 12D, the LC filter portion 108 includes a through-hole pattern 143, a through-hole pattern 144, a through-hole pattern 145, a through-hole pattern 146, a through-hole pattern 147, a through-hole pattern 148, and a through-hole pattern 149.

As illustrated in FIG. 12C, the LC filter portion 108 includes a conductor pattern 150, a conductor pattern 151, a conductor pattern 152, and a conductor pattern 153.

As illustrated in FIG. 12B, the LC filter portion 108 includes a through-hole pattern 154, a through-hole pattern 155, a through-hole pattern 156, and a through-hole pattern 157.

As illustrated in FIG. 12A, the electronic component 100 includes the first terminal electrode 104, the second terminal electrode 105, the third terminal electrode 106, and the fourth terminal electrode 107.

As illustrated in FIG. 12E, the conductor pattern 138 includes an inductor pattern (first inductor pattern) 138A, a connection pattern 138B, a connection pattern 138C, and a connection pattern 138D. The inductor pattern 138A includes a first pattern portion 138Aa and a second pattern portion 138Ab connected to an end portion of the first pattern portion 138Aa. The conductor pattern 141 includes an inductor pattern 141A, a connection pattern 141B, a connection pattern 141C, and a connection pattern 141D. The inductor pattern 141A includes a first pattern portion 141Aa and a second pattern portion 141Ab connected to an end portion of the first pattern portion 141Aa. The conductor pattern 142 includes an inductor pattern 142A, a connection pattern 142B, a connection pattern 142C, and a conductor pattern 142D. The inductor pattern 142A includes a first pattern portion 142Aa and a second pattern portion 142Ab connected to an end portion of the first pattern portion 142Aa.

As illustrated in FIG. 12C, the conductor pattern 152 includes an inductor pattern (first inductor pattern) 152A, an inductor pattern (second inductor pattern) 152B, an inductor pattern 152C, and a connection pattern 152D.

The inductor pattern 152A includes a first pattern portion 152Aa; a second pattern portion 152Ab connected to an end portion of the first pattern portion 152Aa; and a third pattern portion 152Ac connected to an end portion of the second pattern portion 152Ab. The inductor pattern 152B includes a first pattern portion 152Ba; a second pattern portion 152Bb connected to an end portion of the first pattern portion 152Ba; and a third pattern portion 152Bc connected to an end portion of the second pattern portion 152Bb. The inductor pattern 152C includes a first pattern portion 152Ca; a second pattern portion 152Cb connected to an end portion of the first pattern portion 152Ca; and a third pattern portion 152Cc connected to an end portion of the second pattern portion 152Cb.

As illustrated in FIG. 12F, the through-hole pattern 124 connects the conductor pattern 110 and the connection pattern 138D. The through-hole pattern 125 connects the conductor pattern 111 and the conductor pattern 139. The through-hole pattern 126 connects the conductor pattern 112 and the conductor pattern 140. The through-hole pattern 127 connects the conductor pattern 113 and the connection pattern 141D.

The through-hole pattern 128 connects the capacitor pattern 119 and the connection pattern 138C. The through-hole pattern 129 connects the capacitor pattern 114 and the conductor pattern 142D. The through-hole pattern 130 connects the capacitor pattern 120 and the connection pattern 142B. The through-hole pattern 131 connects the capacitor pattern 115 and the connection pattern 141C. The through-hole pattern 132 connects the capacitor pattern 121 and the connection pattern 138B. The through-hole pattern 133 connects the capacitor pattern 122 and the connection pattern 142C. The through-hole pattern 134 connects the capacitor pattern 123 and the connection pattern 141B. The through-hole pattern 135 connects the capacitor pattern 116 and the conductor pattern 139. The through-hole pattern 136 connects the capacitor pattern 117 and the conductor pattern 139. The through-hole pattern 137 connects the capacitor pattern 118 and the conductor pattern 139.

As illustrated in FIG. 12D, the through-hole pattern 143 connects the connection pattern 138D and the conductor pattern 150. The through-hole pattern 144 connects the conductor pattern 139 and the conductor pattern 151. The through-hole pattern 145 connects the conductor pattern 140 and the connection pattern 152D. The through-hole pattern 146 connects the connection pattern 141D and the conductor pattern 153.

As illustrated in FIG. 12B, the through-hole pattern 154 connects the conductor pattern 150 and the first terminal electrode 104. The through-hole pattern 155 connects the conductor pattern 151 and the second terminal electrode 105. The through-hole pattern 156 connects the connection pattern 152D and the third terminal electrode 106. The through-hole pattern 157 connects the conductor pattern 153 and the fourth terminal electrode 107.

As illustrated in FIG. 12E, the inductor pattern 138A, the inductor pattern 142A, and the inductor pattern 141A are disposed side by side. In the present embodiment, as viewed in the second direction D2, the inductor pattern 138A, the inductor pattern 142A, and the inductor pattern 141A are disposed side by side in a direction intersecting with the first direction D1 and the third direction D3.

As illustrated in FIG. 12C, the inductor pattern 152A, the inductor pattern 152B, and the inductor pattern 152C are disposed side by side. In the present embodiment, as viewed in the second direction D2, the inductor pattern 152A, the inductor pattern 152B, and the inductor pattern 152C are disposed side by side in a direction intersecting with the first direction D1 and the third direction D3.

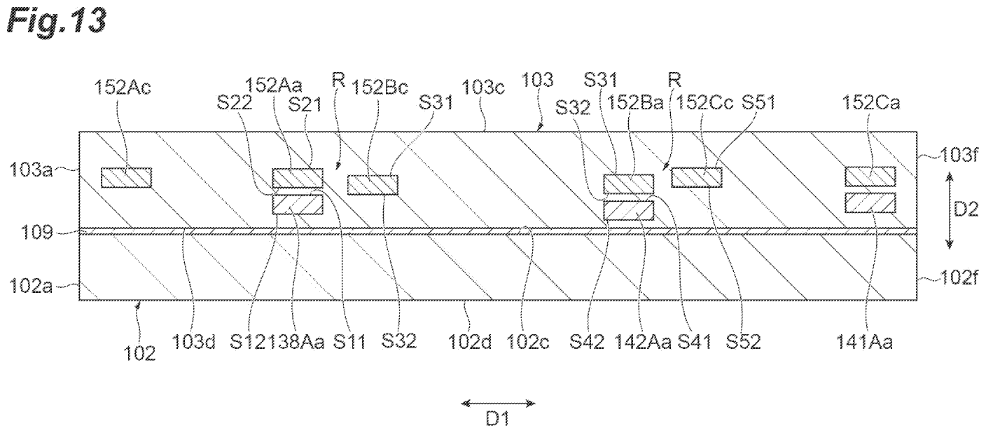

FIG. 13 is a cross-sectional view taken along line XIII-XIII in FIG. 11. In the present embodiment, the inductor pattern 138A, the inductor pattern 141A, the inductor pattern 142A, the inductor pattern 152A, the inductor pattern 152B, and the inductor pattern 152C have the same thickness (dimension in the second direction D2). Incidentally, hereinafter, a direction along line XIII-XIII in FIG. 11 is referred to as a fourth direction.

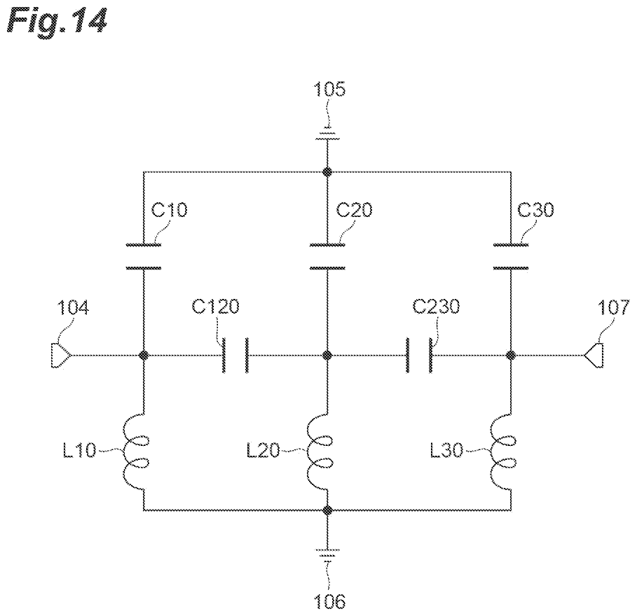

The inductor pattern 152B and both the inductor pattern 138A and the inductor pattern 152A are disposed side by side. Specifically, the third pattern portion 152Bc of the inductor pattern 152B and both the first pattern portion 138Aa of the inductor pattern 138A and the first pattern portion 152Aa of the inductor pattern 152A are disposed side by side. Namely, a first inductor L10 including the inductor pattern 138A and the inductor pattern 152A (refer to FIG. 14) and a second inductor L20 including the inductor pattern 152B (refer to FIG. 14) are disposed adjacent to each other.

The first inductor L10 and the second inductor L20 include different numbers of patterns in the adjacent region R. In the region R where the first inductor L10 and the second inductor L20 are adjacent to each other, the first inductor L10 is such that two inductor pattern 138A and inductor pattern 152A are disposed, and the second inductor L20 is such that one inductor pattern 152B is disposed. The first inductor L10 and the second inductor L20 are magnetically coupled in the adjacent region R. Specifically, the inductor pattern 152B and both the inductor pattern 138A and the inductor pattern 152A are magnetically coupled in the region R.

The inductor pattern 152C and both the inductor pattern 142A and the inductor pattern 152B are disposed side by side. Specifically, the third pattern portion 152Cc of the inductor pattern 152C and both the first pattern portion 142Aa of the inductor pattern 142A and the first pattern portion 152Ba of the inductor pattern 152B are disposed side by side. Namely, the second inductor L20 including the inductor pattern 142A and the inductor pattern 152B (refer to FIG. 14) and a third inductor L30 including the inductor pattern 152C (refer to FIG. 14) are disposed adjacent to each other.

The second inductor L20 and the third inductor L30 include different numbers of patterns in the adjacent region R. In the region R where the second inductor L20 and the third inductor L30 are adjacent to each other, the second inductor L20 is such that two inductor pattern 142A and inductor pattern 152B are disposed, and the third inductor L30 is such that one inductor pattern 152C is disposed. The second inductor L20 and the third inductor L30 are magnetically coupled in the adjacent region R. Specifically, the inductor pattern 152C and both the inductor pattern 142A and the inductor pattern 152B are magnetically coupled in the region R.

The inductor pattern 138A has an upper surface (first surface) S11 and a lower surface (second surface) S12 facing each other in the second direction D2. The upper surface S11 is located toward the main surface (one main surface) 103c. The lower surface S12 is located toward the main surface (the other main surface) 103d. The inductor pattern 152A has an upper surface (first surface) S21 and a lower surface (second surface) S22 facing each other in the second direction D2. The upper surface S21 is located toward the main surface 103c. The lower surface S22 is located toward the main surface 103d. The inductor pattern 152B has an upper surface (third surface) S31 and a lower surface (fourth surface) S32 facing each other in the second direction D2. The upper surface S31 is located toward the main surface 103c. The lower surface S32 is located toward the main surface 103d. The upper surface S11 and the lower surface S12, the upper surface S21 and the lower surface S22, and the upper surface S31 and the lower surface S32 are, for example, flat surfaces.

The upper surface S11 and the lower surface S12 of the inductor pattern 138A and the upper surface S31 and the lower surface S32 of the inductor pattern 152B are at different height positions in the second direction D2. Specifically, the upper surface S11 of the inductor pattern 138A is located closer to the main surface 103d side of the insulator 103 in the second direction D2 than the upper surface S31 of the inductor pattern 152B. In other words, the upper surface S31 of the inductor pattern 152B is located closer to a main surface 103c side of the insulator 103 in the second direction D2 than the upper surface S11 of the inductor pattern 138A. The lower surface S12 of the inductor pattern 138A is located closer to the main surface 103d side of the insulator 103 in the second direction D2 than the lower surface S32 of the inductor pattern 152B. In other words, the lower surface S32 of the inductor pattern 152B is located closer to the main surface 103c side of the insulator 103 in the second direction D2 than the lower surface S12 of the inductor pattern 138A.

The upper surface S21 and the lower surface S22 of the inductor pattern 152A and the upper surface S31 and the lower surface S32 of the inductor pattern 152B are at different height positions in the second direction D2. Specifically, the upper surface S21 of the inductor pattern 152A is located closer to the main surface 103c side of the insulator 103 in the second direction D2 than the upper surface S31 of the inductor pattern 152B. In other words, the upper surface S31 of the inductor pattern 152B is located closer to the main surface 103d side of the insulator 103 in the second direction D2 than the upper surface S21 of the inductor pattern 152A. The lower surface S22 of the inductor pattern 152A is located closer to the main surface 103c side of the insulator 103 in the second direction D2 than the lower surface S32 of the inductor pattern 152B. In other words, the lower surface S32 of the inductor pattern 152B is located closer to the main surface 103d side of the insulator 103 in the second direction D2 than the lower surface S22 of the inductor pattern 152A.

The inductor pattern 152A and the inductor pattern 152B include portions facing each other in the first direction D1. The inductor pattern 152A and the inductor pattern 152B at least partially overlap each other as viewed in the first direction D1. Incidentally, the inductor pattern 152A and the inductor pattern 152B at least partially overlap each other as viewed in the fourth direction.

The inductor pattern 142A has an upper surface S41 and a lower surface S42 facing each other in the second direction D2. The upper surface S41 is located toward the main surface 103c. The lower surface S42 is located toward the main surface 103d. The inductor pattern 152C has an upper surface S51 and a lower surface S52 facing each other in the second direction D2. The upper surface S51 is located toward the main surface 103c. The lower surface S52 is located toward the main surface 103d. The upper surface S41 and the lower surface S42, and the upper surface S51 and the lower surface S52 are, for example, flat surfaces.

The upper surface S41 and the lower surface S42 of the inductor pattern 142A and the upper surface S51 and the lower surface S52 of the inductor pattern 152C are at different height positions in the second direction D2. Specifically, the upper surface S41 of the inductor pattern 142A is located closer to the main surface 103d side of the insulator 103 in the second direction D2 than the upper surface S51 of the inductor pattern 152C. In other words, the upper surface S51 of the inductor pattern 152C is located closer to the main surface 103c side of the insulator 103 in the second direction D2 than the upper surface S41 of the inductor pattern 142A. The lower surface S42 of the inductor pattern 142A is located closer to the main surface 103d side of the insulator 103 in the second direction D2 than the lower surface S52 of the inductor pattern 152C. In other words, the lower surface S52 of the inductor pattern 152C is located closer to the main surface 103c side of the insulator 103 in the second direction D2 than the lower surface S42 of the inductor pattern 142A.

The upper surface S31 and the lower surface S32 of the inductor pattern 152B and the upper surface S51 and the lower surface S52 of the inductor pattern 152C are at different height positions in the second direction D2. Specifically, the upper surface S31 of the inductor pattern 152B is located closer to the main surface 103d side of the insulator 103 in the second direction D2 than the upper surface S51 of the inductor pattern 152C. In other words, the upper surface S51 of the inductor pattern 152C is located closer to the main surface 103c side of the insulator 103 in the second direction D2 than the upper surface S31 of the inductor pattern 152B. The lower surface S32 of the inductor pattern 152B is located closer to the main surface 103d side of the insulator 103 in the second direction D2 than the lower surface S52 of the inductor pattern 152C. In other words, the lower surface S52 of the inductor pattern 152C is located closer to the main surface 103c side of the insulator 103 in the second direction D2 than the lower surface S32 of the inductor pattern 152B.

The inductor pattern 152B and the inductor pattern 152C include portions facing each other in the first direction D1. The inductor pattern 152B and the inductor pattern 152C at least partially overlap each other as viewed in the first direction D1. Incidentally, it can also be said that the inductor pattern 152B and the inductor pattern 152C at least partially overlap each other as viewed in the fourth direction.

As illustrated in FIG. 14, the electronic component 100 includes the first inductor L10, the second inductor L20, the third inductor L30, a first capacitor C10, a second capacitor C20, a third capacitor C30, a fourth capacitor C120, and a fifth capacitor C230.

The first inductor L10 includes the inductor pattern 138A and the inductor pattern 152A. The second inductor L20 includes the inductor pattern 142A and the inductor pattern 152B. The third inductor L30 includes the inductor pattern 141A and the inductor pattern 152C.

The first capacitor C10 is formed of the capacitor pattern 116 and the capacitor pattern 121. The second capacitor C20 is formed of the capacitor pattern 117 and the capacitor pattern 122. The third capacitor C30 is formed of the capacitor pattern 118 and the capacitor pattern 123.

The fourth capacitor C120 is formed of the capacitor pattern 114 and the capacitor pattern 119. The fifth capacitor C230 is formed of the capacitor pattern 115 and the capacitor pattern 120.

The first inductor L10 and the first capacitor C10 form a first LC resonator. The second inductor L20 and the second capacitor C20 form a second LC resonator. The third inductor L30 and the third capacitor C30 form a third LC resonator.

As described above, in the electronic component 100 according to the present embodiment, in the region R where the first inductor L10 and the second inductor L20 are adjacent to each other, at least one of the positions in the second direction D2 of the upper surface S21 of the inductor pattern 152A and the upper surface S31 of the inductor pattern 152B and the positions in the second direction D2 of the lower surface S22 of the inductor pattern 152A and the lower surface S32 of the inductor pattern 152B are different. In such a manner, in the region R where the first inductor L10 and the second inductor L20 are adjacent to each other, namely, in portions that are magnetically coupled, when the positions of the upper surface S21 of the inductor pattern 152A and the upper surface S31 of the inductor pattern 152B and/or the positions of the lower surface S22 of the inductor pattern 152A and the lower surface S32 of the inductor pattern 152B are differentiated, the degree of coupling in magnetic coupling between the first inductor L10 and the second inductor L20 changes. In such a manner, in the electronic component 100, magnetic coupling between the first inductor L10 and the second inductor L20 can be adjusted without depending on the thicknesses of the insulation layers. Therefore, in the electronic component 100, magnetic coupling between the inductors can be finely adjusted.

### Third Embodiment

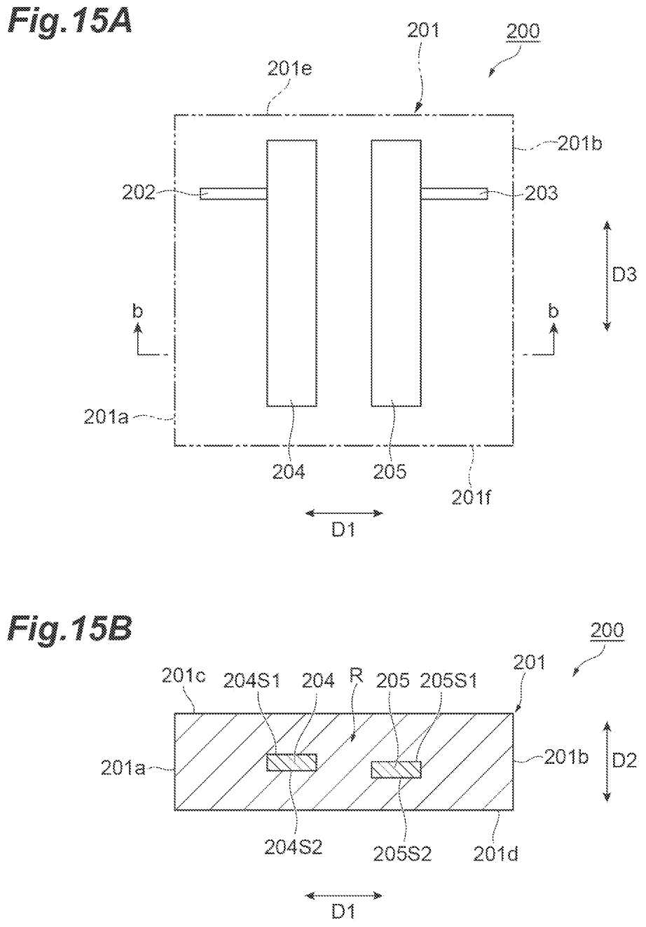

Subsequently, a third embodiment will be described. FIG. 15A is a view illustrating an electronic component according to the third embodiment, and FIG. 15B is a cross-sectional view taken along line b-b in FIG. 15A.

An electronic component 200 illustrated in FIG. 15A is a stripline filter. As illustrated in FIG. 15A, the electronic component 200 includes an insulator (element body) 201, a first terminal 202, a second terminal 203, an inductor pattern (first inductor pattern) 204, and an inductor pattern (second inductor pattern) 205. The first terminal 202 is an input terminal. The second terminal 203 is an output terminal.

The insulator 201 has a rectangular parallelepiped shape. The insulator 201 has a pair of end surfaces 201a and 201b facing each other, a pair of main surfaces 201c and 201d facing each other, and a pair of side surfaces 201e and 201f facing each other, as outer surfaces of the insulator 201. The pair of end surfaces 201a and 201b face each other in the first direction D1. The pair of main surfaces 201c and 201d face each other in the second direction D2. The pair of side surfaces 201e and 201f face each other in the third direction D3.

The insulator 201 is formed by stacking a plurality of insulator layers. The insulator layers may be made of an organic insulation material such as polyimide. The insulator layers are stacked in the second direction D2. Namely, the second direction D2 is a stacking direction. In the actual insulator 201, the plurality of insulator layers are integrated to such an extent that boundaries between the insulator layers cannot be visually distinguished.

The inductor pattern 204 has a rectangular shape. The inductor pattern 204 is connected to the first terminal 202. The inductor pattern 205 has a rectangular shape. The inductor pattern 205 is connected to the second terminal 203. The inductor pattern 204 is disposed toward the end surface 201a in the first direction D1. The inductor pattern 205 is disposed toward the end surface 201b in the first direction D1.

As illustrated in FIG. 15B, in the present embodiment, the inductor pattern 204 and the inductor pattern 205 have the same thickness (dimension in the second direction D2).

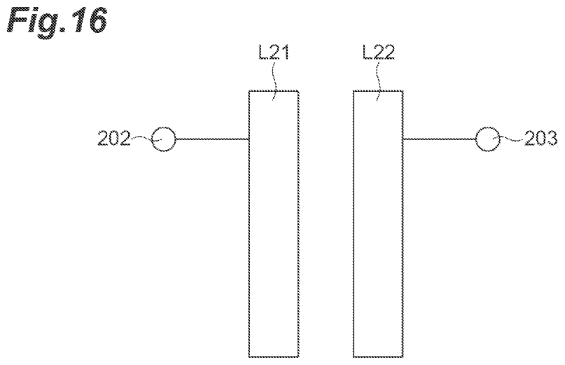

The inductor pattern 204 and the inductor pattern 205 are disposed side by side in the first direction D1 as viewed in the second direction D2. Namely, a first inductor L21 including the inductor pattern 204 (refer to FIG. 16) and a second inductor L22 including the inductor pattern 205 (refer to FIG. 16) are disposed adjacent to each other. The first inductor L21 and the second inductor L22 are magnetically coupled in the adjacent region R.

The inductor pattern 204 includes an upper surface 204S1 and a lower surface 204S2 facing each other in the second direction D2. The upper surface 204S1 is located toward the main surface 201c. The lower surface 204S2 is located toward the main surface 201d. The inductor pattern 205 has an upper surface 205S1 and a lower surface 205S2 facing each other in the second direction D2. The upper surface 205S1 is located toward the main surface 201c. The lower surface 205S2 is located toward the main surface 201d. The upper surface 204S1 and the lower surface 204S2, and the upper surface 205S1 and the lower surface 205S2 are, for example, flat surfaces.

The upper surface 204S1 and the lower surface 204S2 of the inductor pattern 204 and the upper surface 205S1 and the lower surface 205S2 of the inductor pattern 205 are at different height positions in the second direction D2. Specifically, the upper surface 204S1 of the inductor pattern 204 is located closer to a main surface 201c side of the insulator 201 in the second direction D2 than the upper surface 205S1 of the inductor pattern 205. In other words, the upper surface 205S1 of the inductor pattern 205 is located closer to the main surface 201d side of the insulator 201 in the second direction D2 than the upper surface 204S1 of the inductor pattern 204. The lower surface 204S2 of the inductor pattern 204 is located closer to the main surface 201c side of the insulator 201 in the second direction D2 than the lower surface 205S2 of the inductor pattern 205. In other words, the lower surface 205S2 of the inductor pattern 205 is located closer to the main surface 201d side of the insulator 201 in the second direction D2 than the lower surface 204S2 of the inductor pattern 204.

The inductor pattern 204 and the inductor pattern 205 include portions facing each other in the first direction D1. The inductor pattern 204 and the inductor pattern 205 at least partially overlap each other as viewed in the first direction D1.

As illustrated in FIG. 16, the electronic component 200 includes the first inductor L21 and the second inductor L22.

The first inductor L21 includes the inductor pattern 204. The second inductor L22 includes the inductor pattern 205. The first inductor L21 and the second inductor L22 form a λ/2 resonator with both ends open.

As described above, in the electronic component 200 according to the present embodiment, in the region R where the first inductor L21 and the second inductor L22 are adjacent to each other, at least one of the positions in the second direction D2 of the upper surface 204S1 of the inductor pattern 204 and the upper surface 205S1 of the inductor pattern 205 and the positions in the second direction D2 of the lower surface 204S2 of the inductor pattern 204 and the lower surface 205S2 of the inductor pattern 205 are different. In such a manner, in the region R where the first inductor L21 and the second inductor L22 are adjacent to each other, namely, in portions that are magnetically coupled, when the positions of the upper surface 204S1 of the inductor pattern 204 and the upper surface 205S1 of the inductor pattern 205 and/or the positions of the lower surface 204S2 of the inductor pattern 204 and the lower surface 205S2 of the inductor pattern 205 are differentiated, the degree of coupling in magnetic coupling between the first inductor L21 and the second inductor L22 changes. In such a manner, in the electronic component 200, magnetic coupling between the first inductor L21 and the second inductor L22 can be adjusted without depending on the thicknesses of the insulation layers. Therefore, in the electronic component 200, magnetic coupling between the inductors can be finely adjusted.

The embodiments of the present disclosure have been described above; however, the present disclosure is not necessarily limited to the above-described embodiments, and various modifications can be made without departing from the concept of the present disclosure.

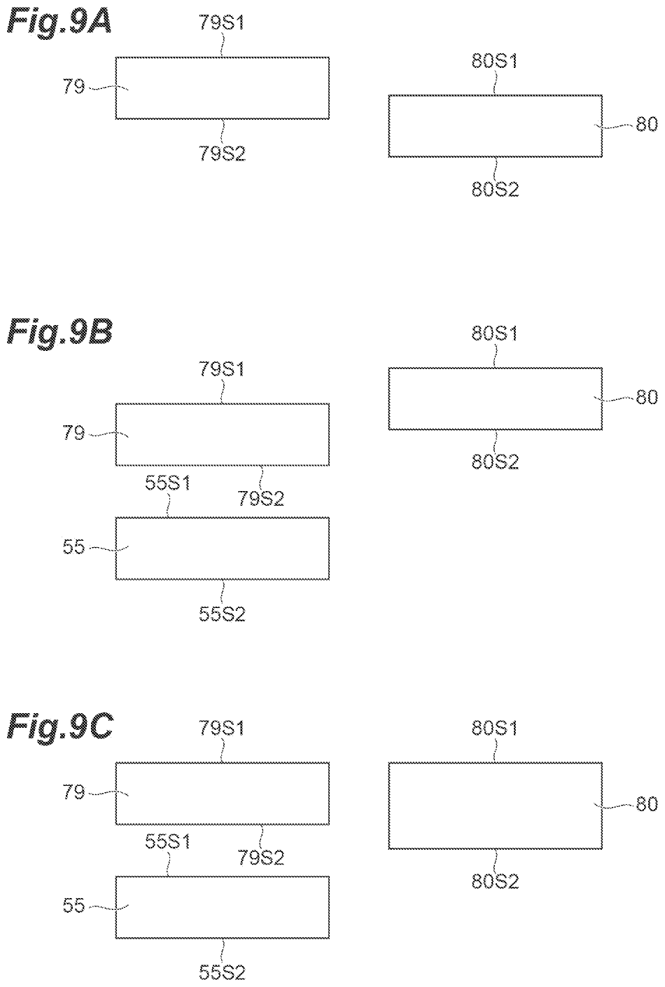

In the first embodiment, the mode in which the first inductor L1 is formed of the inductor pattern 55 and the inductor pattern 79 has been described as one example. However, the first inductor L1 may be formed of only the inductor pattern 79. In this configuration, as illustrated in FIG. 9A, the inductor pattern 79 and the inductor pattern 80 overlap each other in the second direction D2 as viewed in the first direction D1 or the third direction D3. In this configuration, the upper surface 79S1 and the lower surface 79S2 of the inductor pattern 79 and the upper surface 80S1 and the lower surface 80S2 of the inductor pattern 80 are at different height positions in the second direction D2. In this configuration, compared to when the inductor pattern 79 and the inductor pattern 80 are the same position in the second direction D2, namely, when the upper surface 79S1 and the lower surface 79S2 of the inductor pattern 79 and the upper surface 80S1 and the lower surface 80S2 of the inductor pattern 80 are at the same height position in the second direction D2, the degree of coupling in magnetic coupling between the first inductor L1 and the second inductor L2 can be reduced.

In the first embodiment, the mode in which the inductor pattern 80 and both the inductor pattern 55 and the inductor pattern 79 include portions facing each other in the first direction D1 has been described as one example. However, as illustrated in FIG. 9B, the inductor pattern 80 may face only the inductor pattern 79 in the first direction D1. In this configuration, the degree of coupling in magnetic coupling between the first inductor L1 and the second inductor L2 can be reduced.

In the first embodiment, the mode in which the inductor pattern 55, the inductor pattern 57, the inductor pattern 79, the inductor pattern 80, and the inductor pattern 81 have the same thickness has been described as one example. However, as illustrated in FIG. 9C, for example, the thickness of the inductor pattern 80 may be thicker than the thickness of the inductor pattern 55, the inductor pattern 57, the inductor pattern 79, and the inductor pattern 81. Accordingly, for example, the height position of the upper surface 79S1 of the inductor pattern 79 and the height position of the upper surface 80S1 of the inductor pattern 80 in the second direction D2 can be differentiated. In this configuration, since the inductor pattern 80 is magnetically coupled with the inductor pattern 79 and the inductor pattern 55, the degree of coupling in magnetic coupling between the first inductor L1 and the second inductor L2 can be increased.

In the first embodiment, the mode in which the first inductor L1 is formed of the inductor pattern 55 and the inductor pattern 79, each of the second inductor L2 and the third inductor L3 is formed of the inductor pattern 80, and the fourth inductor L4 is formed of the inductor pattern 57 and the inductor pattern 81 has been described as one example. However, the number of inductor patterns forming an inductor may be appropriately set according to the design.

In this configuration, for example, when a first inductor is formed of a plurality of first inductor patterns and a second inductor is formed of a plurality of second inductor patterns, in a region where the first inductor and the second inductor are adjacent to each other in the first direction, at least the positions of upper surfaces and/or the positions of lower surfaces of one first inductor pattern among the plurality of first inductor patterns and of one second inductor pattern among the plurality of second inductor patterns may be different.

In the first embodiment, the mode in which the upper surface 55S1 and the lower surface 55S2 of the inductor pattern 55 are flat surfaces has been described as one example. However, the upper surface 5551 and the lower surface 55S2 may be curved surfaces or uneven surfaces. The same applies to the inductor pattern 57, the inductor pattern 79, the inductor pattern 80, and the inductor pattern 81. The same applies to each inductor pattern illustrated as an example in the second embodiment and the third embodiment. Namely, in the second embodiment, the upper surface S11 and the lower surface S12 of the inductor pattern 138A may be curved surfaces or uneven surfaces. The same applies to the inductor pattern 141A, the inductor pattern 142A, the inductor pattern 152A, the inductor pattern 152B, and the inductor pattern 152C. In addition, in the third embodiment, the upper surface 204S1 and the lower surface 204S2 of the inductor pattern 204 may be curved surfaces or uneven surfaces. The same applies to the inductor pattern 205.

In the first embodiment, the mode in which the first inductor L1 includes the inductor pattern 55 and the inductor pattern 79, the second inductor L2 includes the inductor pattern 80, and the first inductor L1 and the second inductor L2 include different numbers of inductor patterns has been described as one example. However, the first inductor and the second inductor may include the same number of inductor patterns. In this configuration, in a region where the first inductor and the second inductor are adjacent to each other, the numbers of inductor patterns may be different from each other.

In the embodiments, the mode in which the electronic components 1, 100, and 200 are chip components has been described as one example. However, the form of the electronic component is not limited thereto. For example, the electronic component may be one element contained within an assemblage containing a plurality of electronic components. Specifically, for example, when a large number of a plurality of electronic components are obtained using an assembly substrate (wafer) in the manufacturing process of an electronic component, the electronic component may be contained within an assemblage of a plurality of electronic components before being singulated into individual components.

In the third embodiment, in the electronic component 200, the mode in which the first inductor L21 and the second inductor L22 form a λ/2 resonator with both ends open. However, the first inductor L21 and the second inductor L22 may form a λ/2 resonator with both ends short-circuited or may form a λ/4 resonator.

In the third embodiment, the mode in which the inductor pattern 204 and the inductor pattern 205 have a rectangular shape has been described as one example. However, the shape of the inductor pattern 204 and the inductor pattern 205 may be other shapes. For example, the inductor pattern 204 and the inductor pattern 205 may have an annular shape. In this case, the other inductor pattern may be disposed inside one inductor pattern.

The electronic component may be applied to a low temperature co-fired ceramics (LTCC) filter.

What is claimed is:

1. An electronic component comprising:
an element body having a pair of end surfaces facing each other in a first direction, a pair of main surfaces including a first main surface and a second main surface facing each other in a second direction, and a pair of side surfaces facing each other in a third direction; and
an inductor and a capacitor disposed inside the element body and forming a resonator,
wherein the inductor includes a first inductor including a first inductor pattern, and a second inductor including a second inductor pattern,
the first inductor pattern has a first surface located toward the first main surface in the second direction, and a second surface located toward the second main surface in the second direction,
the second inductor pattern has a third surface located toward the first main surface in the second direction, and a fourth surface located toward the second main surface in the second direction,
the first inductor and the second inductor are disposed side by side in the top view from the second direction, and
in a region where the first inductor and the second inductor are adjacent to each other, at least one of positions in the second direction of the first surface of the first inductor pattern and the third surface of the second inductor pattern, and positions in the second direction of the second surface of the first inductor pattern and the fourth surface of the second inductor pattern, are different.

2. The electronic component according to claim 1,
wherein in the region where the first inductor and the second inductor are adjacent to each other, the first inductor pattern and the second inductor pattern each having one or more patterns, the number of the patterns being different from each other.

3. The electronic component according to claim 1,
wherein in the region where the first inductor and the second inductor are adjacent to each other, the first inductor pattern and the second inductor pattern include portions facing each other in the first direction.

4. The electronic component according to claim 3,
wherein the second inductor pattern includes portions that face a plurality of the first inductor patterns.

5. The electronic component according to claim 1,
wherein the first inductor pattern and the second inductor pattern have different thicknesses in the second direction.

6. An electronic component comprising:
an element body having a pair of end surfaces facing each other in a first direction, a pair of main surfaces including a first main surface and a second main surface facing each other in a second direction, and a pair of side surfaces facing each other in a third direction; and
an inductor disposed inside the element body and forming a resonator,
wherein the inductor includes a first inductor including a first inductor pattern, and a second inductor including a second inductor pattern,
the first inductor pattern has a first surface located toward the first main surface in the second direction, and a second surface located toward the second main surface in the second direction,
the second inductor pattern has a third surface located toward the first main surface in the second direction, and a fourth surface located toward the second main surface in the second direction,
the first inductor and the second inductor are disposed side by side in the top view from the second direction, and
in a region where the first inductor and the second inductor are adjacent to each other, at least one of positions in the second direction of the first surface of the first inductor pattern and the third surface of the second inductor pattern, and positions in the second direction of the second surface of the first inductor pattern and the fourth surface of the second inductor pattern, are different.

7. The electronic component according to claim 1,
wherein the first surface of the first inductor pattern is located above the third surface of the second inductor pattern in the second direction.

8. The electronic component according to claim 1,
wherein the second surface of the first inductor pattern is located above the fourth surface of the second inductor pattern in the second direction.

9. The electronic component according to claim 1,
wherein the first inductor pattern is formed over one or more layers in the second direction of the element body,
the second inductor pattern is formed over one or more layers in the second direction of the element body, and
in the region where the first inductor and the second inductor are adjacent to each other, the number of the layers in which the second inductor pattern is formed is less than the number of the layers in which the first inductor pattern is formed.

10. The electronic component according to claim 9,
wherein the first inductor pattern is formed over at least two layers and includes at least two portions in the region where the first inductor and the second inductor are adjacent to each other, each of the two portions being disposed in a different layer among the at least two layers,
the second inductor pattern includes a portion being disposed in the region where the first inductor and the second inductor are adjacent to each other,
the at least two portions of the first inductor pattern each faces the portion of the second inductor pattern in the first direction.

11. The electronic component according to claim 2,
wherein in the region where the first inductor and the second inductor are adjacent to each other, the first inductor pattern and the second inductor pattern include portions facing each other in the first direction.

12. The electronic component according to claim 11,
wherein the second inductor pattern includes portions that face a plurality of the first inductor patterns.
